(19) United States
(12) Patent Application Publication
(10) Pub. No.: US 2026/0058251 A1
(43) Pub. Date: Feb. 26, 2026

(54) BATTERY COOLING DEVICE AND BATTERY COOLING SYSTEM

(71) Applicant: DENSO CORPORATION, Kariya City (JP)

(72) Inventors: Kimio KOHARA, Kariya City (JP); Kenshiro MURAMATSU, Kariya City (JP); Hisashi UMEMOTO, Kariya City (JP); Yasuyuki OBA, Kariya City (JP); Hiroyuki FURUYA, Kariya City (JP)

(21) Appl. No.: 19/378,778

(22) Filed: Nov. 4, 2025

Related U.S. Application Data
(63) Continuation of application No. PCT/JP2024/015242, filed on Apr. 17, 2024.

(30) Foreign Application Priority Data
Jun. 15, 2023 (JP) 2023-098350

(51) Int. Cl. H01M 10/6568; H01M 10/613; H01M 10/617; H01M 10/625; H01M 10/63; H01M 10/653; H01M 10/6551; H01M 10/6557; H01M 10/659

(52) U.S. Cl. CPC H01M 10/6568; H01M 10/613; H01M 10/617; H01M 10/625; H01M 10/63; H01M 10/653; H01M 10/6551; H01M 10/6557; H01M 10/659

(57) ABSTRACT

A battery cooling device applied to an electrically-powered flying object includes: a cooling tank; a plurality of battery cells housed in the cooling tank; an insulating liquid accommodated in the cooling tank to flow therein, and immersing the plurality of battery cells to absorb heat from the plurality of battery cells; and a valve coupling provided at the cooling tank, and configured to detachably attach a low-temperature cooling device to allow the insulating liquid in the cooling tank to flow into and flow out of the low-temperature cooling device. Thus, the temperature of high-temperature battery cells can be made lower than the temperature of the other battery cells, and temperature of the plurality of battery cells can be equalized.

### CROSS REFERENCE TO RELATED APPLICATION

The present application is a continuation application of International Patent Application No. PCT/JP2024/015242 filed on Apr. 17, 2024, which designated the U.S. and claims the benefit of priority from Japanese Patent Application No. 2023-098350 filed on Jun. 15, 2023. The entire disclosures of all of the above applications are incorporated herein by reference.

### TECHNICAL FIELD

The present disclosure relates to a battery cooling device and a battery cooling system.

### BACKGROUND

A battery thermal management system applied to an electrically-powered flying object has been proposed in the past, for example. The battery thermal management system includes a battery pack that is a combination of multiple battery cells, multiple cooling plates, and multiple insulators.

Each battery cell is positioned along an outer wall surface of the cooling plate. Further, battery cells, cooling plates, and insulators are arranged in the order of a battery cell, a cooling plate, a battery cell, an insulator, and a battery cell.

A working fluid circulates inside the cooling plate. In such manner, each battery cell is cooled by each cooling plate. In other words, heat from each battery cell is stored in the working fluid via the cooling plate.

### SUMMARY

According to a first aspect of the present disclosure, a battery cooling device to be applied to an electrically-powered flying object includes: a cooling tank; a plurality of battery cells housed in the cooling tank; an insulating liquid accommodated in the cooling tank to flow therein, and immersing the plurality of battery cells to absorb heat from the plurality of battery cells; and a valve coupling provided at the cooling tank, and configured to detachably attach a low-temperature cooling device, to allow the insulating liquid in the cooling tank to flow into and flow out of the low-temperature cooling device.

According to a second aspect of the present disclosure, a battery cooling system to be applied to an electrically-powered flying object, includes a battery cooling device, a low-temperature cooling device and a controller. The battery cooling device includes a cooling tank, a plurality of battery cells housed in the cooling tank, an insulating liquid accommodated in the cooling tank to flow therein and immersing the plurality of battery cells to absorb heat from the plurality of battery cells, and a valve coupling provided at the cooling tank to detachably attach the low-temperature cooling device and to allow the insulating liquid in the cooling tank to flow into and flow out of the low-temperature cooling device. The low-temperature cooling device is made to cool and store the insulating liquid, and the controller is configured to control the low-temperature cooling device. In the battery cooling system, the battery cooling device and the low-temperature cooling device are connected via the valve coupling to configure a cooling circulation circuit in which the insulating liquid circulates between the battery cooling device and the low-temperature cooling device, and the controller is configured to circulate the insulating liquid pre-cooled by the low-temperature cooling device in the cooling circulation circuit.

According to a third aspect of the present disclosure, a battery cooling system to be applied to an electrically-powered flying object, includes a battery cooling device, a low-temperature cooling device and a controller. The battery cooling device includes a cooling tank, a plurality of battery cells housed in the cooling tank, an insulating liquid accommodated in the cooling tank to flow therein and immersing the plurality of battery cells to absorb heat from the plurality of battery cells, and a valve coupling provided at the cooling tank to detachably attach a low-temperature cooling device and to allow the insulating liquid in the cooling tank to flow into and flow out of the low-temperature cooling device. The low-temperature cooling device is made to cool and store the insulating liquid, and the controller is configured to control the low-temperature cooling device. In addition, the battery cooling device and the low-temperature cooling device are connected via the valve coupling to configure a cooling circulation circuit in which the insulating liquid circulates between the battery cooling device and the low-temperature cooling device, and the controller is configured to introduce the insulating liquid, pre-cooled by the low-temperature cooling device, from the low-temperature cooling device to the battery cooling device, after discharging the insulating liquid inside the cooling tank via the cooling circulation circuit.

### BRIEF DESCRIPTION OF DRAWINGS

The above and other objects, features and advantages of the present disclosure will be more clearly understood from the following detailed description with reference to the accompanying drawings. In the drawings:

FIG. 1 is a schematic diagram showing an eVTOL according to a first embodiment;

FIG. 2 is a diagram showing a battery cooling system;

FIG. 3 is a diagram showing the battery cooling device and a low-temperature cooling device after takeoff;

FIG. 4 is a diagram showing changes in battery output and battery temperature from takeoff to landing of the eVTOL;

FIG. 5 is a cross-sectional view showing a battery cooling device according to a second embodiment;

FIG. 6 is a cross-sectional view showing a modification;

FIG. 7 is a cross-sectional view showing a modification;

FIG. 8 is a cross-sectional view showing a modification;

FIG. 9 is a cross-sectional view showing a battery cooling device according to a third embodiment;

FIG. 10 is a cross-sectional view showing a modification;

FIG. 11 is a cross-sectional view showing a modification;

FIG. 12 is a cross-sectional view showing a battery cooling device according to a fourth embodiment;

FIG. 13 is a cross-sectional view showing a modification;

FIG. 14 is a cross-sectional view showing a modification;

FIG. 15 is a cross-sectional view showing a modification;

FIG. 16 is a top view showing a battery cooling device according to a fifth embodiment;

FIG. 17 is a cross-sectional view taken along the line XVII-XVII of FIG. 16;

FIG. 18 is a perspective view showing an offset fin that is an example of a spacer member;

FIG. 19 is a perspective view showing a corrugated fin that is an example of a spacer member;

FIG. 20 is a perspective view showing a wave fin that is an example of a spacer member;

FIG. 21 is a perspective view of a louver fin that is an example of a spacer member;

FIG. 22 is a top view of a battery cell including an extrusion tube that is an example of a spacer member;

FIG. 23 is a top view of a battery cell including an inner fin tube, which is an example of a spacer member;

FIG. 24 is a cross-sectional view showing a battery cooling device according to a sixth embodiment;

FIG. 25 is a top view showing a modification;

FIG. 26 is a cross-sectional view taken along the line XXVI-XXVI of FIG. 25;

FIG. 27 is a cross-sectional view taken along the XXVII-XXVII of FIG. 25;

FIG. 28 is a cross-sectional view showing a battery cooling device according to a seventh embodiment;

FIG. 29 is a diagram showing a battery cooling system on ground during charging;

FIG. 30 is a cross-sectional view showing a battery cooling device applied to another cooling method;

FIG. 31 is a battery cooling system including the battery cooling device shown in FIG. 30;

FIG. 32 is a cross-sectional view showing a battery cooling device applied to another cooling method;

FIG. 33 is a battery cooling system including the battery cooling device of FIG. 32;

FIG. 34 is a cross-sectional view showing a battery cooling device according to an eighth embodiment;

FIG. 35 is an another cross-sectional view showing the battery cooling device according to the eighth embodiment; and

FIG. 36 is an another cross-sectional view showing the battery cooling device according to the eighth embodiment.

### EMBODIMENTS FOR CARRYING OUT INVENTION

A battery thermal management system applied to an electrically-powered flying object has been proposed in the past, for example. The battery thermal management system includes a battery pack that is a combination of multiple battery cells, multiple cooling plates, and multiple insulators.

However, in the battery thermal management system, there is an interface between the battery cell and the cooling plate, as well as an interface between an inner wall of the cooling plate and the working fluid, so that it is difficult for heat to transfer from the battery cells to the working fluid. Thus, in the battery pack, the cooling (heat storage) performance for each battery cell and the temperature equalization performance of each battery cell may be reduced.

In particular, when the battery pack is applied to an electrically-powered flying object, the temperature of the battery cell rises rapidly in a short time due to the large current flowing through each battery cell during takeoff and landing. When the battery cells are two-dimensionally arranged in a large number, temperature distribution among the battery cells is likely to occur depending on the arrangement position of each of the battery cells. Therefore, high-temperature battery cells deteriorate more rapidly than other battery cells.

Therefore, it is desirable to reduce the temperature of the high-temperature battery cell down to the temperature of the other battery cells. In addition, it is desirable to equalize the temperature of each battery cell in order to reduce the difference in output and degradation of each battery cell. Further, it is desirable to cool each battery cell rapidly on the ground after landing.

In view of the above, it is an object of the present disclosure to provide a battery cooling device and a battery cooling system applied to an electrically-powered flying object with a structure that is capable of ensuring equalization of temperature among multiple battery cells while lowering temperature of a high-temperature battery cell below that of other battery cells.

In order to achieve the above-described object, according to a first aspect of the present disclosure, a battery cooling device to be applied to an electrically-powered flying object includes: a cooling tank; a plurality of battery cells housed in the cooling tank; an insulating liquid accommodated in the cooling tank to flow therein, and immersing the plurality of battery cells to absorb heat from the plurality of battery cells; and a valve coupling provided at the cooling tank, and configured to detachably attach a low-temperature cooling device, to allow the insulating liquid in the cooling tank to flow into and flow out of the low-temperature cooling device.

According to a second aspect of the present disclosure, a battery cooling system to be applied to an electrically-powered flying object, includes a battery cooling device, a low-temperature cooling device and a controller. The battery cooling device includes a cooling tank, a plurality of battery cells housed in the cooling tank, an insulating liquid accommodated in the cooling tank to flow therein and immersing the plurality of battery cells to absorb heat from the plurality of battery cells, and a valve coupling provided at the cooling tank to detachably attach the low-temperature cooling device and to allow the insulating liquid in the cooling tank to flow into and flow out of the low-temperature cooling device. The low-temperature cooling device is made to cool and store the insulating liquid, and the controller is configured to control the low-temperature cooling device. In the battery cooling system, the battery cooling device and the low-temperature cooling device are connected via the valve coupling to configure a cooling circulation circuit in which the insulating liquid circulates between the battery cooling device and the low-temperature cooling device, and the controller is configured to circulate the insulating liquid pre-cooled by the low-temperature cooling device in the cooling circulation circuit.

According to a third aspect of the present disclosure, a battery cooling system to be applied to an electrically-powered flying object, includes a battery cooling device, a low-temperature cooling device and a controller. The battery cooling device includes a cooling tank, a plurality of battery cells housed in the cooling tank, an insulating liquid accommodated in the cooling tank to flow therein and immersing the plurality of battery cells to absorb heat from the plurality of battery cells, and a valve coupling provided at the cooling tank to detachably attach a low-temperature cooling device and to allow the insulating liquid in the cooling tank to flow into and flow out of the low-temperature cooling device. The low-temperature cooling device is made to cool and store the insulating liquid, and the controller is configured to control the low-temperature cooling device. In addition, the battery cooling device and the low-temperature cooling device are connected via the valve coupling to configure a cooling circulation circuit in which the insulating liquid circulates between the battery cooling device and the low-temperature cooling device, and the controller is configured to introduce the insulating liquid, pre-cooled by the low-temperature cooling device, from the low-temperature cooling device to the battery cooling device, after discharging the insulating liquid inside the cooling tank via the cooling circulation circuit.

According to the above, the heat from each battery cell is absorbed by the insulating liquid, thereby lowering the temperature of the high-temperature battery cell below the temperature of the other battery cells, while suppressing the temperature rise of each battery cell.

Further, the plurality of battery cells are immersed in the insulating liquid inside the cooling tank, which causes the insulating liquid to flow (convection). Therefore, the temperature variation among the battery cells can be suppressed and the temperature among the respective battery cells can be equalized.

Further, after the landing of the electrically-powered flying object, the low-temperature cooling device can be connected to the valve coupling so as to force cooling of the insulating liquid and each battery cell. Thus, the temperature of each battery cell and the insulating liquid inside the cooling tank can be rapidly reduced.

The following is a description of several embodiments of implementing the present disclosure with reference to the drawings. In each embodiment, parts corresponding to the elements described in the preceding embodiments are denoted by the same reference numerals, and redundant explanation may be omitted. If only a part of the configuration is described in each embodiment, other embodiments described earlier can be applied to the other parts of such configuration.

It is possible to combine parts that are specifically indicated as combinable in each embodiment. It is also possible to partially combine embodiments with each other, embodiments with variations, and variations with each other, even if it is not explicitly stated that such combination is possible, as long as there are no particular obstacles to such combination.

### First Embodiment

The battery cooling device of the present embodiment is mounted on an electrically-powered flying object. The electrically-powered flying object is capable of flying with a driving power of a rotating electric machine.

An electrically-powered flying object is, for example, an electric vertical takeoff and landing (eVTOL) aircraft, an electric short-distance takeoff and landing (eSTOL) aircraft, a drone and the like. The eVTOL is an abbreviation of an electric Vertical Take-Off and Landing aircraft. The eSTOL is an abbreviation of an electric Short-distance Take-Off and Landing aircraft. The following describes an example of a battery cooling device mounted on an eVTOL.

<eVTOL>

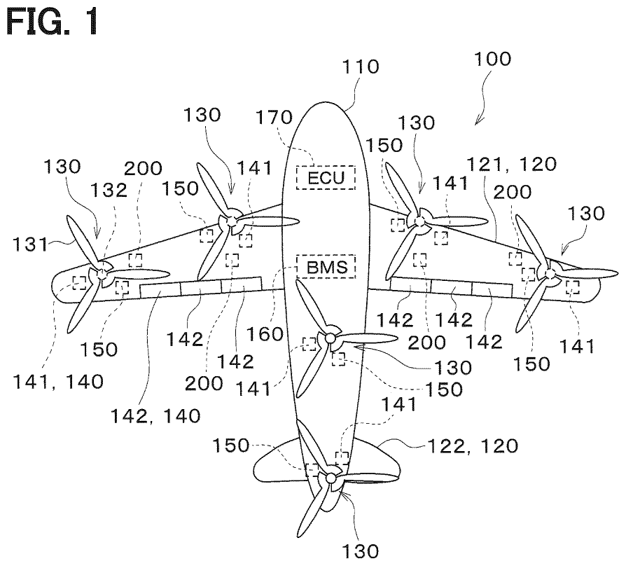

As shown in FIG. 1, as an example, an eVTOL 100 includes an airframe 110, a fixed wing 120, a rotary wing 130, a lift adjustment mechanism 140, a battery cooling device 200, an EPU 150, a BMS 160, and an ECU 170.

The airframe 110 is a fuselage of an aircraft. The airframe 110 has a shape that extends frontward and rearward. The airframe 110 of the aircraft has a crew compartment for crews and/or a cargo compartment for carrying cargo.

The fixed wing 120 is a wing section of the aircraft and is connected to the airframe 110. The fixed wing 120 provides glide lift. Glide lift is a lift generated by the fixed wing 120. As an example, the fixed wing 120 has a main wing 121 and a tail wing 122. The main wing 121 extends from a near-center position of the airframe 110 in a front-rear direction to the left and right. The tail wing 122 extends from a rear part of the airframe 110 to the left and right. The shape of the fixed wing 120 is not particularly limited. For example, a retreating wing, a triangular wing, or a straight wing and the like can be employed.

There are multiple rotary wings 130 provided on the airframe. At least some of the multiple rotary wings 130 may be provided on the fixed wing 120. At least some of the multiple rotary wings 130 may be provided on the airframe 110. The number of rotary wings 130 provided on one eVTOL 100 is not limited. As an example, multiple rotary wings 130 are provided on each of the airframe 110 and the main wings 121. The eVTOL 100 has six rotary wings 130.

The rotary wings 130 may also be referred to as rotors, propellers, fans, or the like. The rotary wing 130 includes a blade 131 and a shaft 132. The blade 131 is attached to the shaft 132. The blade 131 is a vane that rotates with the shaft 132. Multiple blades 131 extend radially around an axis of the shaft 132. The shaft 132 is a rotation axis of the rotary wing 130, and is driven by a motor of the EPU 150.

The rotary wings 130 generate propulsion by rotation. Propulsion acts on the eVTOL 100 primarily as rotational lift during takeoff and landing of the eVTOL 100. The rotary wings 130 primarily provide rotational lift during takeoff and landing. Rotational lift is a lift generated by the rotation of the rotary wings 130. During takeoff and landing, the rotary wings 130 may provide only the rotational lift, or may provide forward thrust along with the rotational lift. The rotary wings 130 provide the rotational lift when the eVTOL 100 is hovering.

Propulsion acts on the eVTOL 100 primarily as thrust when the eVTOL 100 is cruising. The rotary wings 130 primarily provide thrust during cruise. During cruising, the rotary wings 130 may provide thrust only, or may provide lift along with thrust.

The lift adjustment mechanism 140 adjusts glide lift of the fixed wing 120. The lift adjustment mechanism 140 increases or decreases the glide lift generated by the fixed wing 120. The lift adjustment mechanism 140 adjusts the glide lift by, for example, adjusting at least one of a surface area size, an angle of attack (AOA), a camber (wing curvature), a stall AOA, and a wing speed of the fixed wing 120. AOA is an abbreviation of Angle Of Attack. As an example, the lift adjustment mechanism 140 has a tilt mechanism 141 and a flap 142.

The tilt mechanism 141 is driven to adjust a tilt angle of the rotary wings 130. The tilt mechanism 141, together with a motor, an inverter and the like that drive the tilt mechanism 141, constitute a tilt adjustment device. The tilt adjustment device, including the tilt mechanism 141, is provided for each of the rotary wings 130, for example. The tilt mechanism 141 adjusts the tilt angle of the rotary wings 130 by adjusting a tilt of the rotary wings 130 relative to the airframe.

During takeoff and landing, the tilt mechanism 141 controls the tilt angle so that the axis of each of the rotary wings 130 approaches a position where it is parallel to a vertical direction (i.e., up-down direction). As a result, the propulsion from the rotation of each rotary wing 130 acts on the eVTOL 100 primarily as a rotational lift. Thus, the eVTOL 100 can perform takeoffs and landings over short distances and in the vertical direction. In FIG. 1, the vertical direction is perpendicular to the surface of the paper.

During cruising, the tilt mechanism 141 controls the tilt angle so that the axis of each of the rotary wings 130 approaches a position where it is parallel to the horizontal direction. As a result, the propulsion from the rotation of each of the rotary wings 130 acts on the eVTOL 100 primarily as thrust. Thus, the eVTOL 100 can move forward due to the forward thrust from the rotation of each of the rotary wings 130, while obtaining glide lift by the fixed wing 120. Further, the glide lift can be adjusted by changing a wing speed through thrust.

The tilt mechanism 141 is not limited to the example described above in which it is provided separately for each of the rotary wings 130. For example, the tilt angles of multiple rotary wings 130 arranged side by side may be controlled by a common tilt mechanism. The rotary wing 130 may be configured as an integral part with a portion of the wing section, and the wing section and the rotary wing 130 may be configured to be integrally displaced by the tilt mechanism.

The flap 142 is a movable wing piece, and is provided on the fixed wing 120. The flap 142, together with the motor, the inverter, and other devices that drive the flap 142, constitute a flap adjustment device. The flap 142 may also be referred to as a high-lift device. As an example, multiple flaps 142 are provided at a rear edge of the main wing 121. Each of the multiple flaps 142 is equipped with a motor and an inverter. The flap 142 may be provided on the tail wing 122 in addition to the main wing 121. The flap 142 may be provided on a leading edge of the fixed wing 120.

The flap 142 adjusts the surface area size and the camber of the fixed wing 120. For example, controlling the flaps 142 on the main wing 121 to a downward position increases the glide lift acting on the main wing 121. In addition, the flaps 142 can be moved to protrude from the main wing 121 to further increase glide lift.

The lift adjustment mechanism 140 is not limited to the tilt mechanism 141 and the flap 142 described above. A tilt mechanism that adjusts a tilt of the fixed wing 120 relative to the airframe 110 may be employed as the lift adjustment mechanism 140. In such case, the angle of attack of the fixed wing 120 can be adjusted. As the lift adjustment mechanism 140, a rotary wing for generating thrust provided separately from the rotary wing 130 may be employed. In such case, the wing speed can be adjusted. It is also possible to make the rotary wings 130 dedicated to lift (e.g., rotational lift) by providing rotary wings for generating thrust.

Variable wings may be employed as the lift adjustment mechanism 140. Lift can be adjusted by varying the surface area size, the camber, a mounting angle, and the like of the fixed wing 120. As the lift adjustment mechanism 140, a high-lift device other than the flaps 142, e.g., a slat, may be employed. The slats are provided on the leading edge of the main wing 121. By moving the slat forward with respect to the main wing 121, a gap can be formed at a position between the slat and the main wing 121, to delay separation. Thus, the lift can be increased up to a greater angle of attack without stalling. In other words, it can delay the stall AOA.

The battery cooling device 200 has multiple battery cells, which are described later, and is capable of cooling each of the multiple battery cells. Each of the battery cells is a rechargeable secondary battery capable of storing DC (direct current) power. Each of the battery cells provides electric power to the EPU 150, the ECU 170, the tilt adjustment device, and the flap adjustment device. Further, each of the battery cells also supplies electric power to auxiliary equipment, such as air conditioning units and other equipment not shown in the drawing.

As an example, the eVTOL 100 of the present embodiment includes multiple battery cooling devices 200. The multiple battery cooling devices 200 may be connected in series and/or parallel with each other, or they may be independently arranged without being connected to each other. The battery cooling device 200 may be installed separately for the EPU 150 or redundantly for the EPU 150.

Here, the battery cooling device 200 is heavy because the multiple battery cells include dozens or hundreds of cells, for example. Therefore, each battery cooling device 200 is arranged at two positions on each side of the main wing 121 to balance the airframe 110. Of course, the battery cooling device 200 may be arranged on the airframe 110.

The EPU 150 has a motor and an inverter, and rotates and drives the rotary wings 130 that provide propulsion to the eVTOL 100. EPU is an abbreviation of Electric Propulsion Unit. As an example, the EPU 150 is provided on the same number as the rotary wings 130. In other words, the eVTOL 100 has six EPUs 150. The EPU 150 is connected to the rotary wing 130 on a one-to-one basis. Alternatively, two or more rotary wings 130 may be, via a gearbox, connected to a single EPU 150.

The BMS 160 monitors the status of each battery pack in the battery cooling device 200. BMS is an abbreviation of Battery Management System. One BMS 160 is provided for each battery cooling device 200, for example. The BMS 160 may, for example, (a) predict an abnormality in each of the battery cooling devices 200 or (b) detect an abnormality in each of the battery cooling devices 200, by monitoring the status of each battery pack in each of the multiple battery cooling devices 200.

The ECU 170 controls the flight of the eVTOL 100. ECU is an abbreviation of Electronic Control Unit. The ECU 170 controls the eVTOL 100 to fly in a flight state according to (a) the pilot's control, (b) remote control by the pilot, or (c) control by the control system. The ECU 170 performs flight control based on the detection results of the BMS 160 and various sensors. The ECU 170 controls the drive of, for example, the motor of the EPU 150, the motor of the tilt adjustment device, and the motor of the flap adjustment device. The ECU 170 may also perform control of auxiliary device.

### <Battery Cooling System>

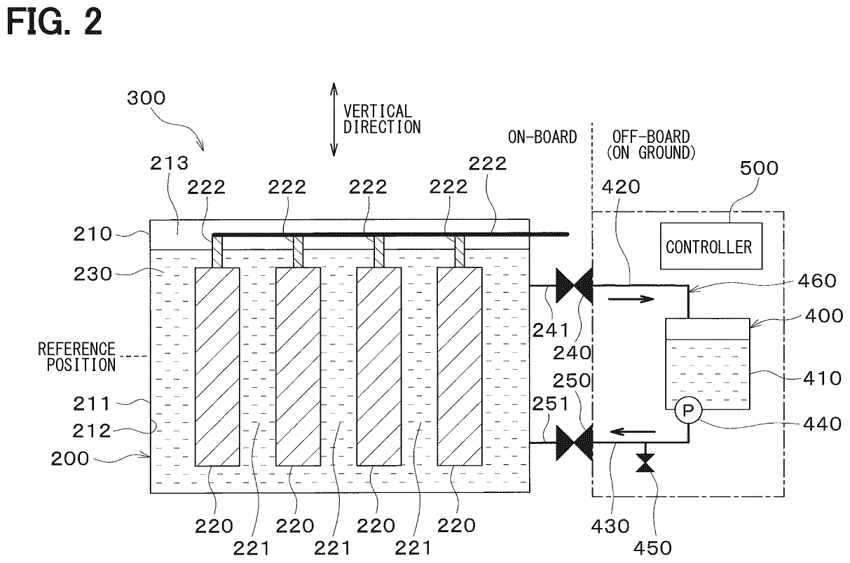

As shown in FIG. 2, a battery cooling system 300 includes the battery cooling device 200, a low-temperature cooling device 400, and a controller 500. The up-down direction of the eVTOL 100 when being stationary on the ground is shown as the vertical direction. The vertical direction means that, an upper side points to the sky above and a lower side points to the ground below.

The battery cooling device 200 includes a cooling tank 210, multiple battery cells 220, an insulating liquid 230, and valve couplings 240 and 250.

The cooling tank 210 constitutes a housing of the battery cooling device 200. The cooling tank 210 includes an outer wall surface 211 and an inner wall surface 212, as well as a space 213 therein. The cooling tank 210 is formed by resin such as CFRP or metal such as Al.

The cooling tank 210, for example, is configured to have a lid as an upper side thereof in the top and bottom direction. The lid can be attached to and detached from the rest of the other part of the cooling tank 210. In such manner, multiple battery cells 220 are moved in and out of the space 213 of the cooling tank 210. The inside of the cooling tank 210 may or may not be completely sealed.

The battery cell 220 is a rechargeable battery that generates an electromotive voltage through a chemical reaction. The battery cell 220 is, for example, a lithium-ion secondary battery, nickel-metal hydride secondary battery, organic radical battery, or the like. The battery cell 220 can be a secondary battery with a liquid electrolyte or a so-called all-solid-state battery with a solid electrolyte.

The multiple battery cells 220 share a common structure with each other. The number and arrangement of the multiple battery cells 220 is not limited. The multiple battery cells 220 may be connected (i) in series or (ii) in parallel and in series. As an example, the battery cells 220 in the present embodiment are connected in series. An electrically-connected structure of the multiple battery cells 220 may sometimes be referred to as a battery assembly. A battery assembly is a so-called battery pack. The multiple battery cells 220 are housed in the space 213 of the cooling tank 210.

The battery cell 220 includes a power generating element and a battery case that houses the power generating element. The battery case provides an outer shell of the battery cells 220. The battery case is formed, for example, using metal materials. The shape of the battery cell 220, or the battery case, is not limited. For example, cylindrical or square shapes can be adopted. As an example, the battery cell 220 in the present embodiment has a square shape, specifically a thin flat shape.

The battery cell 220 is, for example, a laminated battery. The battery cell 220 has a top surface, a bottom surface, and four side surfaces. The top surface is an upper side in the vertical direction. The bottom surface is a surface opposite to the top surface in the vertical direction, and is a surface on the ground side. The side surfaces are surfaces that connect the top and bottom surfaces, and are surfaces along the vertical direction.

The multiple battery cells 220 are arranged side by side in a direction perpendicular to the vertical direction. Further, the multiple battery cells 220 are arranged next to each other with a spacing 221. Each of the battery cells 220 includes two electrode terminals.

One electrode terminal is electrically connected to the positive electrode of the battery cell 220. One electrode terminal is sometimes referred to as a positive terminal, P terminal, etc. The other electrode terminal is electrically connected to the negative electrode of the battery cell 220. The other electrode terminal is sometimes referred to as a negative terminal, N terminal, etc. Electrode terminals are sometimes referred to as current-collecting tabs.

The multiple battery cells 220 are arranged so that positions of the top surfaces are approximately equal to each other in the vertical direction. The relative positions of the multiple battery cells 220 are fixed by a fixing member not shown. The fixing member can be a case, for example, or a restraining member such as a band.

In the above arrangement, each battery cell 220 is electrically connected to the electrode terminals of the adjacent battery cells 220 to each other by bus bars 222, which are wiring members. In other words, the multiple battery cells 220 are connected in series by the bus bars 222.

Two bus bars 222, one for the positive electrode and one for the negative electrode, protrude from the space 213 of the cooling tank 210 to the outside of the cooling tank 210. When the cooling tank 210 is composed of metal material, electrical insulation between the cooling tank 210 and the bus bar 222 is achieved by placing an insulating component, such as an insulating seal member, at a position of the cooling tank 210 through which the bus bar 222 passes. Note that one of the two bus bars is visible in FIG. 2, and insulating components are omitted in FIG. 2.

The insulating liquid 230 is a heat medium that is flowably accommodated in the space 213 of the cooling tank 210. The insulating liquid 230 immerses each battery cell 220, and absorbs heat of each battery cell. Further, the insulating liquid 230 is provided on the space 213 of the cooling tank 210 so that at least part of the bus bar 222 is in direct contact with the insulating liquid 230.

The insulating liquid 230 is provided on the cooling tank 210 so that air remains in an upper part of the space 213 in the cooling tank 210. In such manner, suppression of a condition is achievable, in which a pressure in the space 213 becomes excessively high due to (i) thermal expansion of the insulating liquid 230 as its temperature rises, (ii) evaporation, or other causes.

For example, a non-flammable, fluorinated liquid can be employed as the insulating liquid 230. Non-flammable means that the substance or object does not burn and does not easily spread flame by sparks or heat, as well as being non-flammable. The non-flammable, fluorinated insulating liquid 230 can inhibit the thermal chain or prevent the thermal chain itself in the event of a thermal runaway of the battery cell 220. In other words, the fluorinated insulating liquid 230 has the advantage of being safe.

The non-flammable, fluorinated insulating liquid 230 has a boiling point of, for example, 100 to 250 degrees in Celsius. In contrast, the normal operating temperature of the battery cells 220 is, for example, 10 to 60 degrees in Celsius. Therefore, the non-flammable, fluorinated insulating liquid 230 does not boil during normal use of the battery cell 220. However, if the temperature of the battery cell 220 rises, the non-flammable, fluorinated insulating liquid 230 boils, thereby suppressing the temperature rise of the thermally-runaway battery cell 220. It can also inhibit and prevent heat chain of the battery cells 220.

If the boiling point of the insulating liquid 230 is low, such as 100 degrees in Celsius, the abnormally high-temperature battery cell 220 can be boiled and cooled at a low temperature, while the other normal battery cell 220 can be used at a relatively low temperature. If the boiling point of the insulating liquid 230 is high, for example 250 degrees in Celsius, the insulating liquid 230 is unlikely to evaporate during normal use. In other words, the insulating liquid 230 has a low vapor pressure. Therefore, the advantage that there is less leakage of the insulating liquid 230 from the cooling tank 210 to the outside is achievable.

As non-flammable, fluorinated insulating liquids 230, for example, Galden (registered trademark) manufactured by Solvay, Asahi Klin (registered trademark) manufactured by AGC, and Opteon (registered trademark) manufactured by Chemers can be employed.

As another example of the insulating liquid 230, oil can be employed. The oil is less volatile, so there is less leakage from the cooling tank 210 to the outside. It is also inexpensive.

As oils, for example, SPECTRASYN (registered trademark) from ExxonMobil, SYNFLUID (registered trademark) from Chevron Phillips Chemicals, and MIVOLT (registered trademark) from M&I Materials can be employed. Other oils, such as AmpCool from Engineered Fluids and silicone oil from Shin-Etsu Chemical, can also be employed.

The valve couplings 240 and 250 are the connections to which the low-temperature cooling device 400 is attached and detached. In other words, the cooling tank 210 is attached and detached to/from the low-temperature cooling device 400 via the valve couplings 240 and 250. The valve couplings 240 and 250 allow passage of the insulating liquid 230 when connected to the low-temperature cooling device 400, while blocking passage of the insulating liquid 230 when not connected to the low-temperature cooling device 400.

For example, the valve couplings 240 and 250 are manually switched to an open state after the low-temperature cooling device 400 is connected. Further, the valve couplings 240 and 250 are manually switched to a closed state before connection to the low-temperature cooling device 400 is released. Alternatively, the low-temperature cooling device 400 may be mechanically switched to the open state when connected to the valve couplings 240 and 250. Further, the low-temperature cooling device 400 may be mechanically switched to the closed state when disconnected from the valve couplings 240 and 250.

The center position of the cooling tank 210 in the vertical direction is defined as a reference position. In the present embodiment, one valve coupling 240 is connected to a pipe 241 in the cooling tank 210 that is arranged above the reference position. The other valve coupling 250 is connected to a pipe 251 in the cooling tank 210 that is disposed at a lower position than the reference position. Thus, for example, when discharging the insulating liquid 230 inside the cooling tank 210 to the outside via the valve coupling 250 provided at the bottom of the cooling tank 210, discharging of the insulating liquid 230 inside the cooling tank 210 to the outside is performable by gravity. In such case, the insulating liquid 230 existing at a position above the valve coupling 250 in the vertical direction can be discharged to the outside.

Both of the valve couplings 240 and 250 may be disposed at a lower position in the vertical direction than the reference position in the cooling tank 210. Alternatively, both of the valve couplings 240 and 250 may be disposed at a position above the reference position in the cooling tank 210 in the vertical direction. In other words, the valve couplings 240 and 250 need only be provided at the position in the cooling tank 210 where the insulating liquid 230 is present. By shifting the positions of the valve couplings 240 and 250 in the vertical or horizontal direction, more of the insulating liquid 230 can be discharged from the cooling tank 210, and making the insulating liquid 230 less stagnant (non-flowing) for circulation therein. Further, each of the valve couplings 240 and 250 may be installed directly in the cooling tank 210 without the respective pipes 241 and 251.

The low-temperature cooling device 400 is a device that cools and stores the insulating liquid 230. Further, the low-temperature cooling device 400, via the connection to the valve couplings 240 and 250 of the cooling tank 210, allows the insulating liquid 230 inside the cooling tank 210 to flow out, or to flow in from the outside.

The low-temperature cooling device 400 has a tank 410 for storing the insulating liquid 230, pipes 420 and 430 connected to the tank 410, and a pump 440 that pumps the insulating liquid 230 in the tank 410 to a pipe 430. Although not shown in the drawing, the low-temperature cooling device 400 also has cooling equipment to cool and keep the temperature of the insulating liquid 230 in the tank 410.

The pipes 420 and 430 are, for example, hoses. One pipe 420 is connected to one valve coupling 240. The other pipe 430 is connected to the other valve coupling 250. Thus, the battery cooling device 200 and the low-temperature cooling device 400 are connected via the valve couplings 240, 250 and pipes 420, 430 to form a cooling circulation circuit 460 which circulates the insulating liquid 230 between the battery cooling device 200 and the low-temperature cooling device 400.

The other pipe 430 may have a discharge valve 450 to discharge the high-temperature insulating liquid 230 in the cooling tank 210. In such manner, the high-temperature insulating liquid 230 inside the cooling tank 210 is quickly discharged. Of course, the discharge valve 450 does not have to be provided on the other pipe 430. If the cooling circulation circuit 460 only circulates the insulating liquid 230, the discharge valve 450 is not required.

The low-temperature cooling device 400 is provided for each of the battery cooling devices 200, for example. Alternatively, a single low-temperature cooling device 400 may have multiple pairs of pipes 420 and 430 in parallel. In such case, each of the pipes 420 and 430 is connected to each of the battery cooling devices 200.

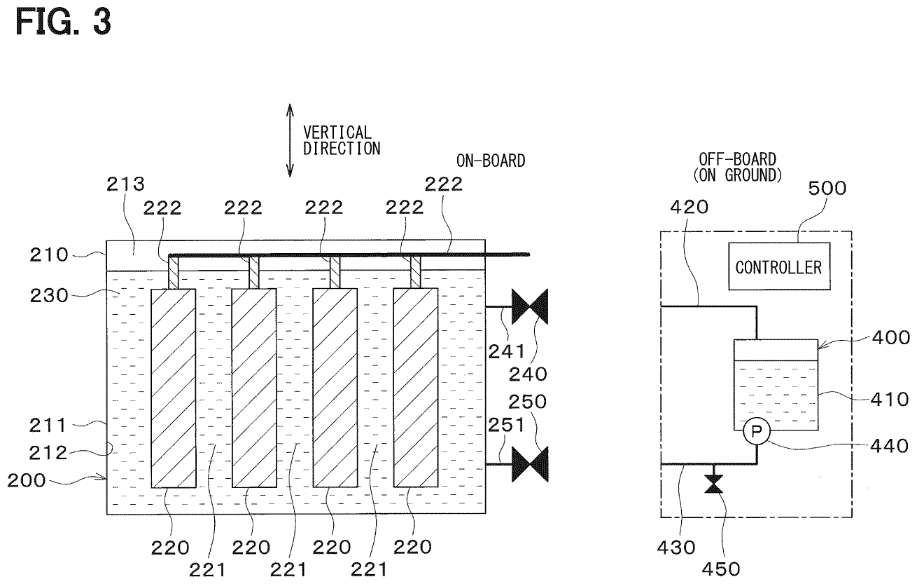

The low-temperature cooling device 400 is connected to the cooling tank 210 after the landing of the eVTOL 100. As shown in FIG. 3, during takeoff, cruise, and landing of the eVTOL 100, the battery cooling device 200 is detached from the low-temperature cooling device 400 and is disposed in a cabin of the eVTOL 100. The low-temperature cooling device 400 is disposed outside the eVTOL 100.

The low-temperature cooling device 400 may be connected to the cooling tank 210 at the same time as the landing of the eVTOL 100. Further, the low-temperature cooling device 400 may be detached from the cooling tank 210 at the same time as the takeoff of the eVTOL 100.

The controller 500 is a device that controls the low-temperature cooling device 400. The controller 500 controls, for example, the number of rotations (pumping capacity) of the pump 440 and the cooling temperature of the cooling section. The controller 500 consists of a well-known microcomputer including a processor, ROM and RAM, and peripheral circuits. The controller 500 performs various calculations and processing based on a control program stored in ROM.

When multiple low-temperature cooling devices 400 are provided, the controller 500 may be provided for each of the battery cooling devices 200, or a single controller 500 may be used to control multiple battery cooling devices 200.

### <Cooling Method>

Next, the cooling method for cooling each of the battery cells 220 is described. As shown in FIG. 3, during takeoff, cruise, and landing of the eVTOL 100, heat from each battery cell 220 is stored in the insulating liquid 230 in the cooling tank 210. In such manner, cooling of each of the battery cells 220 is performed.

On the other hand, after the landing of the eVTOL 100, each of the battery cooling devices 200 on the eVTOL 100 is connected to the low-temperature cooling device 400, as shown in FIG. 2. In such manner, the cooling circulation circuit 460 is configured between the battery cooling device 200 and the low-temperature cooling device 400.

The controller 500 circulates the insulating liquid 230 pre-cooled by the low-temperature cooling device 400 into the cooling circulation circuit 460 by using the pump 440. For example, the insulating liquid 230 at low temperature is allowed to flow into the cooling tank 210 via the valve coupling 250 that is disposed at the bottom of the cooling tank 210, and the insulating liquid 230 at high temperature is returned to the tank 410 of the low-temperature cooling device 400 via the valve coupling 240 that is disposed at the top of the cooling tank 210. In such case, the pump 440 is controlled to pump the insulating liquid 230 at low temperature into the pipe 430. In such manner, rapid cooling of each battery cell 220 inside the cooling tank 210 is performed by the circulation of the insulating liquid 230 in the cooling circulation circuit 460.

The low-temperature insulating liquid 230 may be allowed to flow into the cooling tank 210 via the valve coupling 240 disposed at the top of the cooling tank 210, and the high-temperature insulating liquid 230 may be returned to the tank 410 of the low-temperature cooling device 400 via the valve coupling 250 provided at the bottom of the cooling tank 210. In such case, the pump 440 is controlled to pump the insulating liquid 230 at low temperature into the pipe 420.

### <Flight Pattern>

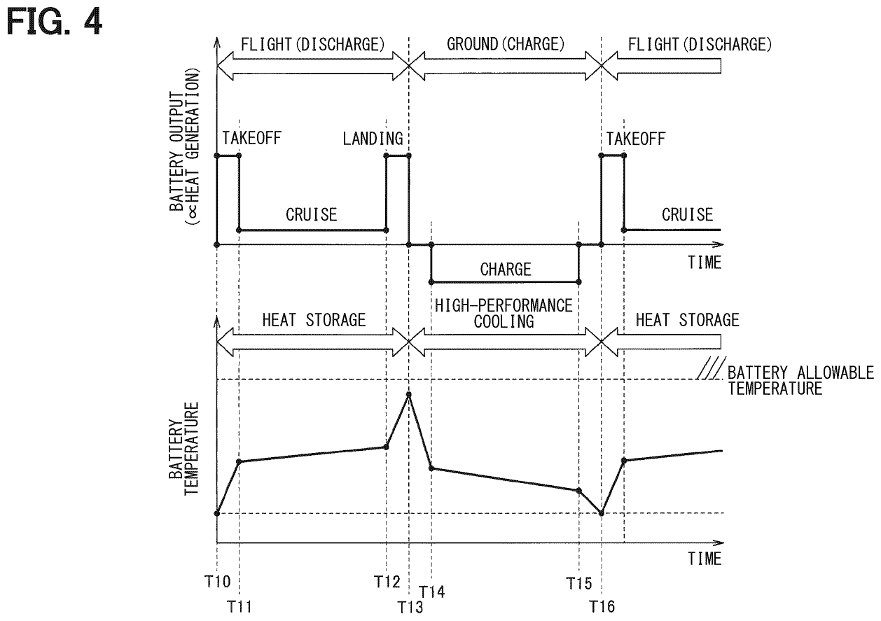

FIG. 4 shows an example of the most simplified flight pattern of the eVTOL 100 from takeoff to landing. The flight pattern of the electrically-powered flying object other than the eVTOL 100 is also similar to those of the eVTOL 100.

The period from time T10 to time T11 is referred to as a takeoff period, a takeoff time, a departure period, a departure time, or the like. In the following, the period from time T10 to time T11 is referred to as the takeoff time. Takeoff refers to an ascent of the eVTOL 100 from its landed state to its cruising altitude. The period from time T11 to time T12 is referred to as a cruising period, a cruising time, or the like. The period from time T12 to time T13 is referred to as a landing period, a landing time, an arrival period, an arrival time, or the like. In the following, the period from time T12 to time T13 is referred to as the landing time. Landing refers to an operation of the eVTOL 100 from the cruising altitude at the destination to its landing on the ground. For convenience, FIG. 4 assumes that the required electric power, or output, is constant for almost the entire duration of each of those periods.

The eVTOL 100 ascends from the position of takeoff to the altitude of a cruise start point during the period from time T10 to time T11. The eVTOL 100 cruises at a predetermined altitude during the period from time T11 to time T12. The eVTOL 100 descends from the altitude at a cruise end point to the landing point during the period from time T12 to time T13.

The movement of the eVTOL 100 mainly includes a horizontal component during cruise, and mainly includes a vertical component during takeoff and landing. During takeoff and landing, when moving in the vertical direction, high output power is required to drive the rotary wings 130 of the eVTOL 100 for a given continuous period of time.

Such a high output power puts a heavy load on each of the battery cells 220 and the EPU 150, which are the driving equipment used to drive the rotary wings 130. For example, each of the battery cells 220 generates heat, causing its temperature to rise. This is because the heat generated by each of the battery cells 220 is proportional to its output.

After the landing of the eVTOL 100, each of the battery cells 220 is charged on the ground. When each of the battery cells 220 is fully charged, the eVTOL 100 takes off again and begins cruising.

During flight time (discharge time) and the grounded time (charge time) of the eVTOL 100, the battery temperature of each of the battery cells 220 changes as described below. First, during takeoff, the battery temperature in each of the battery cells 220 rises rapidly. During cruising, the battery temperature in each of the battery cells 220 rises slowly because the battery output is not required as much as during takeoff. During landing, the battery temperature in each of the battery cells 220 rises rapidly because the same battery output is required as during takeoff.

During the period of flight time (discharge time) from time T10 to time T13, i.e., from when the eVTOL 100 takes off to when it lands, the insulating liquid 230 in the battery cooling device 200 stores heat of each of the battery cells 220 for heat storage cooling. In such manner, because the temperature rise of the high output battery cell 220 is suppressed to have heat storage cooling while heat is transferred to the other low output (low temperature) battery cells 220 via the insulating liquid 230, the temperature of the high-temperature battery cell 220 further lowers and the temperature of the low-temperature battery cell 220 rises. In other words, temperature of the battery cells 220 is equalized. Thus, at time T13, when landing of the eVTOL 100 is complete, temperature of each of the battery cells 220 is controlled not to exceed an allowable temperature.

One of the objects of equalization of the temperature among the battery cells 220 is to avoid high temperature of a particular battery cell 220, i.e., a safety concern, which would affect the performance (safety) of the entire battery pack. For example, in case that a particular battery cell 220 has high temperature while many other battery cells 220 still have room to reach the upper limit temperature, the remaining flight continuation time of the entire battery pack may possibly be restricted, urging an emergency response, such as shifting to an emergency landing pattern or the like. However, when it is possible to lower the temperature of the high temperature battery cell 220, an in-flight emergency response is avoidable.

The period from time T13 to time T16 is a grounded (charging) period during which (a) each of the battery cells 220 is charged on the ground and (b) each of the battery cells 220 receives high-performance cooling. First, at time T13, each of the battery cooling devices 200 of the eVTOL 100 is connected to the low-temperature cooling device 400. According to the above, the battery temperature rapidly drops as the insulating liquid 230 at low temperature circulates through the cooling circulation circuit 460, as described above.

Further, during a period between time T13 and time T14, the bus bar 222 of the battery cooling device 200 is connected to a charging equipment. When the battery cooling device 200 is connected to the low-temperature cooling device 400, the bus bar 222 of the battery cooling device 200 may be connected to the charging equipment at the same time. The charging equipment may be included in the low-temperature cooling device 400 or may be independent of the low-temperature cooling device 400.

Charging of each of the battery cells 220 begins at time T14. Accordingly, each of the battery cells 220 generates heat, resulting in a slower decrease in the battery temperature. When the charging of each of the battery cells 220 is complete at time T15, each of the battery cells 220 and the bus bar 222 no longer generate heat, thereby the battery temperature drops rapidly due to cooling by the low-temperature insulating liquid 230. Thus, high-performance cooling for each of the battery cells 220 is complete at time T16. After time T16, the flight (discharge) and grounding (charge) of from time T10 to time T16 described above are repeated.

As explained above, in the battery cooling device 200 of the present embodiment, the multiple battery cells 220 are housed in the cooling tank 210 and each of the battery cells 220 is immersed in the insulating liquid 230. Further, the insulating liquid 230 can flow inside the cooling tank 210, and the valve couplings 240 and 250 are provided on the cooling tank 210 to allow connection and disconnection of the low-temperature cooling device 400, which is external to the cooling tank 210.

In such manner, the temperature rise and temperature distribution among the battery cells 220 are suppressible during takeoff, cruise, and landing of the eVTOL 100, since heat generated by each of the battery cells 220 is absorbed by the flowable insulating liquid 230 directly immersing each of the battery cells 220. Further, the multiple battery cells 220 can be immersed in the insulating liquid 230 in a single cooling tank 210, which causes the insulating liquid 230 to flow (i.e., convection is caused in the cooling tank 210), thus equalizing the temperature among the multiple battery cells 220. Therefore, the temperature of a particular battery cell 220, which is highest among all battery cells 220 can be lowered, and in turn, the temperature of all battery cells 220 can be leveled (equalized).

Further, during grounded time of the eVTOL 100, especially during charging of each of the battery cells 220, the low-temperature cooling device 400 capable of circulating and cooling the insulating liquid 230 is connected to the valve couplings 240 and 250 of the cooling tank 210 to circulate the insulating liquid 230 in the cooling circulation circuit 460. In such manner, each of the battery cells 220 in the cooling tank 210 is forcibly cooled. Thus, temperature of each of the battery cells 220 is lowered while charging each of the battery cells 220.

Further, instead of having a cooling equipment for the multiple battery cells 220, i.e., instead of having multiple pieces of cooling equipment for all battery cells 220, a single cooling tank 210 can be used to cool all battery cells 220. Thus, increase of the weight of the battery cooling device 200 as well as increase in size are avoidable.

In the battery cooling device 200 of the present embodiment, at least a part of the bus bar 222 is immersed in the insulating liquid 230. Thus, the temperature of the bus bar 222 can be lowered. Further, heat is absorbed from inside of each of the battery cells 220 to the insulating liquid 230 via the bus bar 222. Thus, temperature distribution within each of the battery cells 220 is reducible.

### Second Embodiment

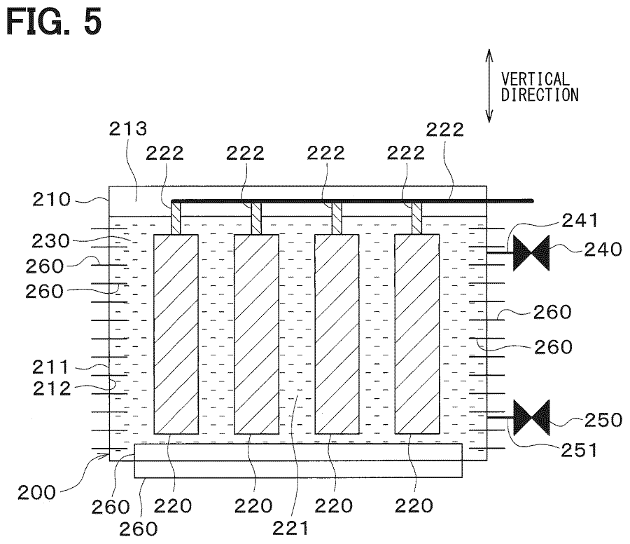

The second embodiment mainly describes the difference from the first embodiment. As shown in FIG. 5, a cooling tank 210 has fins 260. The fins 260 function to dissipate heat from inside of the cooling tank 210 to the outside. In addition to heat dissipation, the fins 260 also function as ribs. The ribs are reinforcing ribs that reinforce the strength of the cooling tank 210.

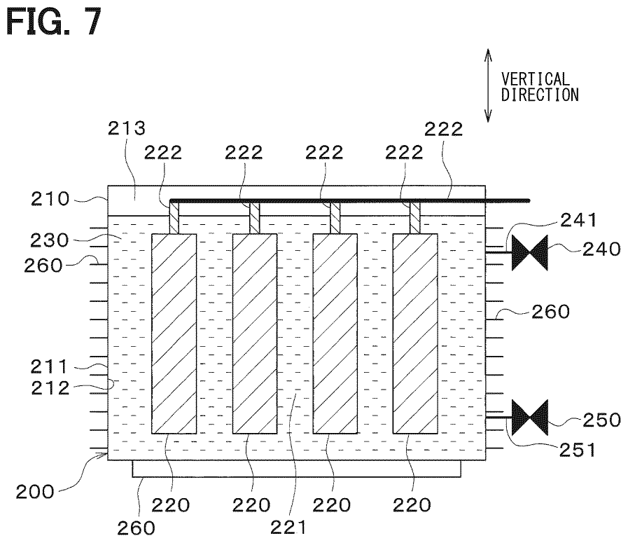

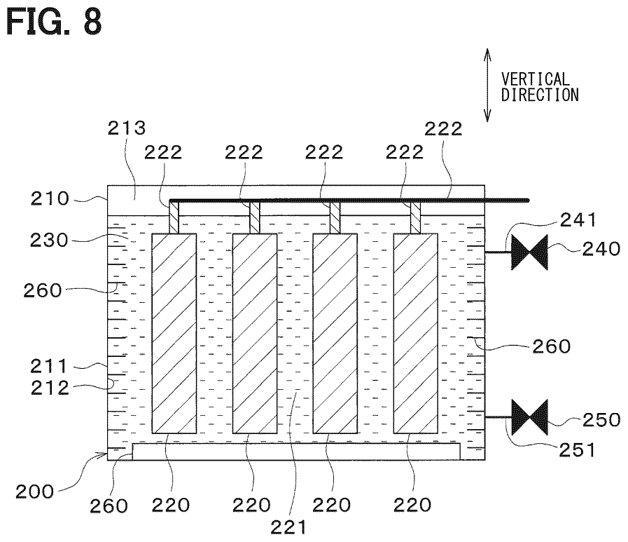

The fins 260 are provided on both of an outer wall surface 211 and an inner wall surface 212 that make up the cooling tank 210. As shown in FIGS. 7 and 8 below, the fin 260 may be provided on either of the outer wall surface 211 or the inner wall surface 212. The fins 260 are provided on the outer wall surface 211 and the inner wall surface 212 of the cooling tank 210, corresponding to an area where the insulating liquid 230 is present.

The fins 260 may be provided on an area where an insulating liquid 230 is not present. For example, fins 260 may be provided on the outer wall surface 211 and the inner wall surface 212 of the lid portion of the cooling tank 210.

The fins 260 are integrally formed on the cooling tank 210. The fin 260 may be provided as a separate part from the cooling tank 210 and may be integrated to the cooling tank 210 by bonding.

When the cooling tank 210 is composed of a metal such as Al, the fins 260 are formed integrally with the cooling tank 210, for example, by die casting, extrusion, forging, or other methods. When the metal cooling tank 210 and the metal fins 260 are prepared as separate parts, the fins 260 are bonded to the cooling tank 210 by welding, brazing, bonding or the like, for example. When the fin 260 is made of metal, the fin 260 should preferably be made of the same material as the cooling tank 210.

Alternatively, when the cooling tank 210 is made of CFRP or other resin, the fins 260 are formed integrally with the cooling tank 210 by injection molding, extrusion, or other methods, for example. When the resin cooling tank 210 and the resin fins 260 are prepared as separate parts, the fins 260 are bonded to the cooling tank 210 by bonding, welding, or the like, for example. When the fins 260 are made of resin, the fins 260 should preferably be made of the same material as the cooling tank 210.

Of course, the cooling tank 210 and the fin 260 may be integrated by bonding the resin fin 260 to the metal cooling tank 210, or the fin 260 and the cooling tank 210 may be integrated by bonding the metal fin 260 to the resin cooling tank 210.

According to the above-described configuration, the fins 260 reduce the thermal resistance from each of the battery cells 220 to the outside of the cooling tank 210, making it easier to dissipate heat from inside of the cooling tank 210 to the outside. Thus, the temperature rise of each of the battery cells 220 can be suppressed. The fins 260 can also improve the strength of the cooling tank 210, since the cooling tank 210 also functions as ribs. In such manner, the cooling tank 210 is made lighter.

Here, a flight wind may be used to promote heat dissipation from the cooling tank 210. In such case, the cooling tank 210 is mounted on a main wing 121 of an eVTOL 100 so that it is exposed from the main wing 121. Alternatively, the cooling tank 210 is mounted on the main wing 121 so that the flight wind introduced from the outer wall of the main wing 121 to the inside of the main wing 121 directly hits the cooling tank 210. By promoting heat dissipation in such manner, heat dissipation performance of the cooling tank 210 by the fins 260 is improved.

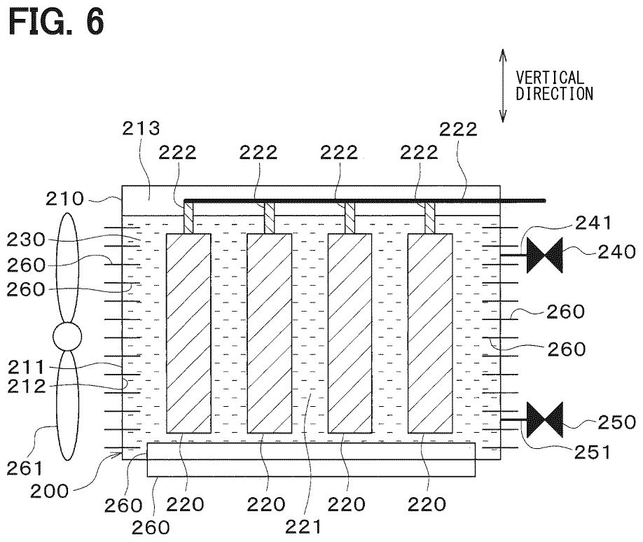

As a modification, as shown in FIG. 6, a fan 261 may be installed next to the cooling tank 210 to promote heat dissipation from the cooling tank 210. The fan 261 may be fixed to the cooling tank 210 via a separate component, or may be fixed to an internal structure of the main wing 121 of the eVTOL 100. In such manner, heat dissipation from the cooling tank 210 is further promoted, by forcing wind to hit the fins 260 of the cooling tank 210.

The fan 261 is controlled, for example, by a BMS 160. Of course, the fan 261 may be controlled by a different controller than the BMS 160. For example, it may be controlled by a dedicated device for the fan 261. Alternatively, it may be controlled by other controllers on board in the eVTOL 100.

The fan 261 is arranged in a front part of the cooling tank 210 in a travel direction of the eVTOL 100, for example. The number of fans 261 is not limited to one; multiple fans 261 may be arranged outside the cooling tank 210. For example, one fan 261 may be arranged on one outer wall surface 211 of the cooling tank 210, or multiple fans 261 may be arranged on one outer wall surface 211.

As another modification, as shown in FIG. 7, the fins 260 may be provided only on the outer wall surface 211 of the cooling tank 210. As shown in FIG. 8, the fins 260 may be provided only on the inner wall surface 212 of the cooling tank 210.

Alternatively, the fins 260 may be provided only on a specific outer wall surface 211 from among the surfaces comprising the cooling tank 210, only on a specific inner wall surface 212, or on both of a specific outer wall surface 211 and a specific inner wall surface 212. In other words, in one cooling tank 210, the fins 260 may be positioned only on the outer wall surface 211, may be positioned only on the inner wall surface 212, or may be positioned on both of the outer wall surface 211 and the inner wall surface 212.

### Third Embodiment

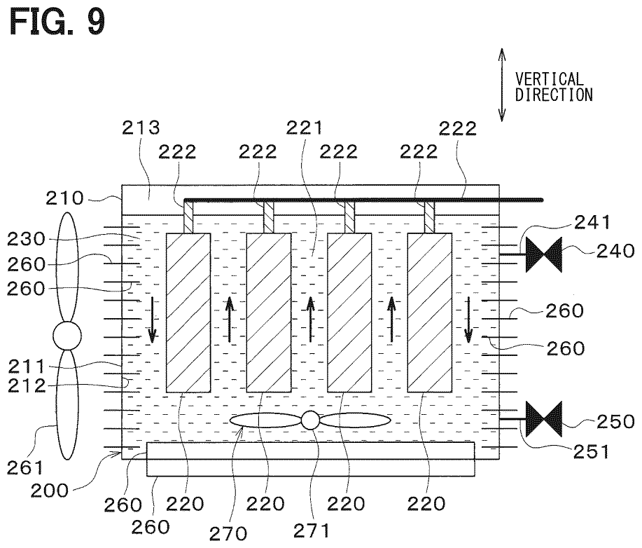

The present embodiment mainly describes the parts that differ from the first and second embodiments. As shown in FIG. 9, a cooling tank 210 is equipped with a flow device 270 for flowing an insulating liquid 230. In the present embodiment, the flow device 270 is a stirring device 271.

The stirring device 271 has, for example, a stirring wing, a shaft fixed to the stirring wing, and a drive device to rotate the shaft. The stirring device 271 is arranged, for example, at the bottom of the inside of the cooling tank 210. The stirring wings rotate to send an insulating liquid 230 from the bottom to the top of the cooling tank 210.

A drive device of the stirring device 271 is controlled by a BMS 160, for example. Of course, the drive device of the stirring device 271 may be controlled by a different controller than the BMS 160. For example, it may be controlled by a dedicated device for the drive device of the stirring device 271. Alternatively, it may be controlled by other controllers on board in the eVTOL 100.

According to the above-described configuration, the stirring device 271 moves part of the insulating liquid 230 from the bottom to the top of the cooling tank 210, and the insulating liquid 230 at a distance from the stirring device 271 moves from the top to the bottom of the cooling tank 210. In other words, the insulating liquid 230 is stirred in the cooling tank 210. Thus, the cooling performance of the cooling tank 210 is improved and the equalization of temperature of the battery cells 220 is promoted.

As shown in FIG. 9, the cooling and equalization performance can be improved by combining fin 260 or fan 261 with the stirring device 271. Of course, the cooling tank 210 may be equipped only with the stirring device 271, without fins 260 or fan 261. The stirring device 271 is not limited to the one that is arranged at the bottom of the cooling tank 210, but can be arranged anywhere as long as it can generate flow of the insulating liquid 230. Further, the number of the stirring device 271 is not limited to one, but multiple stirring devices 271 may be provided on the cooling tank 210.

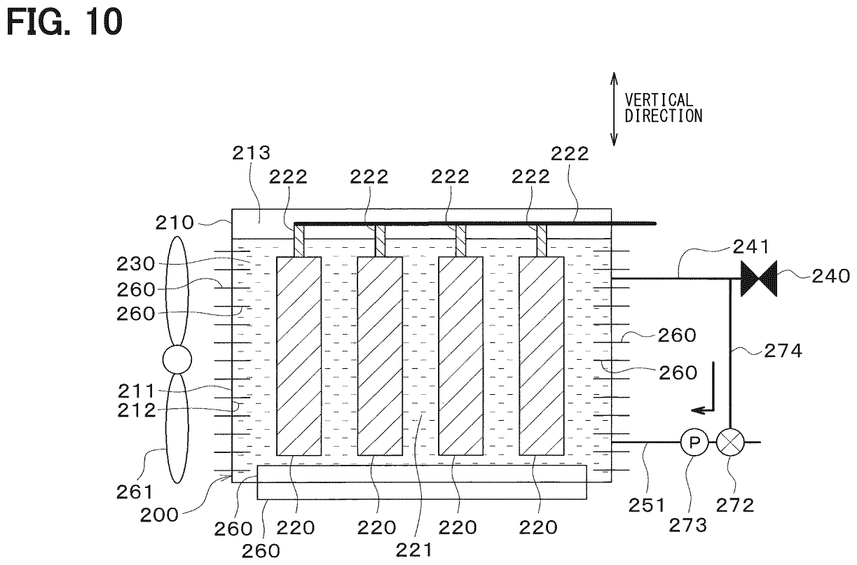

As a modification, as shown in FIG. 10, the flow device 270 may be configured to have a pipe 241, a pipe 251, a three-way valve 272, a pump 273, and a pipe 274. The three-way valve 272 and the pump 273 are connected to the pipe 251 in a lower part of the cooling tank 210, and the pipe 241 in an upper part of the cooling tank 210 is connected to the three-way valve 272 via the pipe 274. In such manner, a path is formed for circulating the insulating liquid 230 through the cooling tank 210, the pipe 241, the pipe 251, the three-way valve 272, the pump 273, and the pipe 241.

The three-way valve 272 is a solenoid valve that switches the states in which the insulating liquid 230 in the upper part of the cooling tank 210 either flows into the lower part of the cooling tank 210 or not. The pump 273 pumps the insulating liquid 230 flowing from the pipe 241 through the three-way valve 272 to the bottom of the cooling tank 210.

The three-way valve 272 and the pump 273 are controlled by the BMS 160, for example. Of course, the three-way valve 272 and the pump 273 may be controlled by a different controller than the BMS 160. For example, they may be controlled by a dedicated device for controlling the three-way valve 272 and the pump 273. Alternatively, they may be controlled by other controllers on board in the eVTOL 100.

During the flight time (discharge time) of the eVTOL 100, the three-way valve 272 connects the pipe 274 and the pipe 251. Further, the pump 273 pumps the insulating liquid 230 to the bottom of the cooling tank 210. In such manner, the insulating liquid 230 circulates through the cooling tank 210, the pipe 241, the pipe 274, and the pipe 251, thereby allowing each of the battery cells 220 to be cooled efficiently and allowing temperature equalization among the battery cells 220.

During the grounded (charge) time of the eVTOL 100, the three-way valve 272 shuts off the pipe 274 and the pipe 251. Further, the three-way valve 272 is connected to the pipe 430 of the low-temperature cooling device 400. In other words, the three-way valve 272 functions as a valve coupling. In such manner, the low-temperature insulating liquid 230 from the low-temperature cooling device 400 is pumped into the cooling tank 210.

The insulating liquid 230 may be pumped from the low-temperature cooling device 400 to the cooling tank 210 by operating the pump 273 attached externally to the cooling tank 210 during the grounded (charge) time of the eVTOL 100. Of course, both of the pump 440 of the low-temperature cooling device 400 and the pump 273 of the cooling tank 210 may be operated to pump the insulating liquid 230 into the cooling tank 210. During the grounded (charge) time of the eVTOL 100, a controller 500 may control the three-way valve 272 and the pump 273.

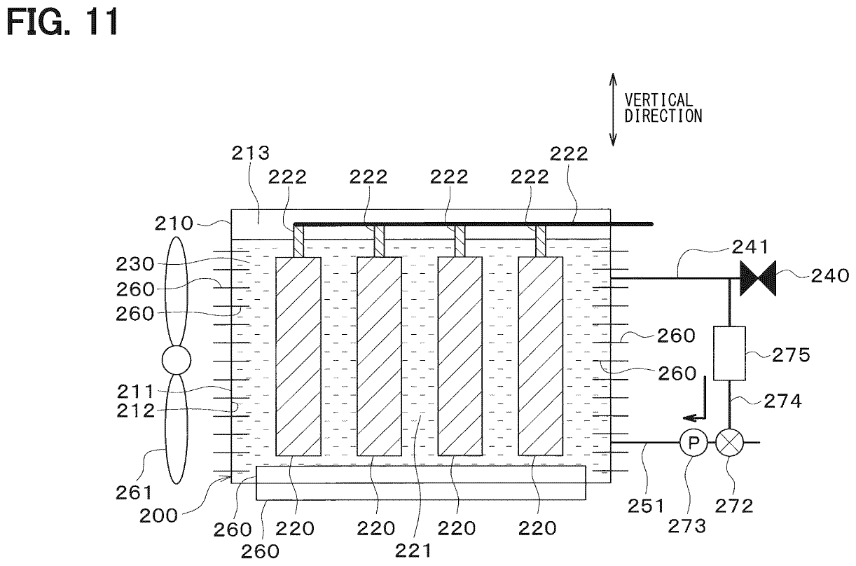

As another modification, as shown in FIG. 11, the flow device 270 may be configured to have of the pipe 241, the pipe 251, the three-way valve 272, the pump 273, the pipe 274, and a heat exchanger 275. The heat exchanger 275 is connected to the external pipe 274 of the cooling tank 210. The heat exchanger 275 is dedicated to the cooling tank 210, for example. The heat exchanger 275 disposed on the eVTOL 100 may be used as a substitution.

The heat exchanger 275 is, for example, a radiator or a chiller. The radiator exchanges heat between the insulating liquid 230 and air. The chiller exchanges heat between the insulating liquid and a refrigerant in a refrigeration cycle.

As described above, by providing the heat exchanger 275 on the pipe 274, cooling of the insulating liquid 230 is performable during the flight (discharge) time of the eVTOL 100. Therefore, the low-temperature insulating liquid 230 can always be supplied to each of the battery cells 220, thereby further improving the cooling performance of the insulating liquid 230 and the equalization performance of each of the battery cells 220.

The three-way valve 272 in the present embodiment corresponds to a valve coupling.

### Fourth Embodiment

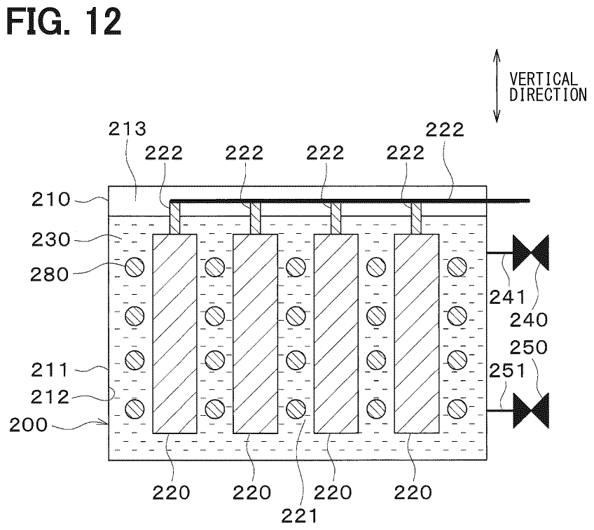

The present embodiment mainly describes the parts that differ from the first through third embodiments. As shown in FIG. 12, a cooling tank 210 includes a latent heat storage material 280 that produces a cooling storage effect.

The latent heat storage material 280 is sometimes referred to as PCM. PCM is an abbreviation of Phase Change Material. The latent heat storage material 280 stores or dissipates heat by using latent heat in and out of the material as a result of phase change. In the present embodiment, a resin heat storage material containing microcapsule latent heat storage material is used as the latent heat storage material 280. The microcapsule latent heat storage material is a heat storage material in which the latent heat storage material is enclosed in a microcapsule.

As the latent heat storage material 280, a latent heat storage material with a phase change temperature (melting point) of 60 degrees in Celsius or lower can be employed. Specifically, paraffinic hydrocarbon, hydrate, metallic, and water-based latent heat storage materials can be employed as the latent heat storage material 280, for example.

The latent heat storage material 280 is added to an insulating liquid 230. A certain amount of the latent heat storage material 280 with respect to the insulating liquid 230 is included in the insulating liquid 230, and is dispersed in the insulating liquid 230. In such manner, the thermal capacity of the insulating liquid 230 containing the latent heat storage material 280 increases.

Then, during the flight (discharge) time of an eVTOL 100, both of the insulating liquid 230 and the latent heat storage material 280 absorb heat from each of battery cells 220. Therefore, the temperature rise of each of the battery cells 220 can be effectively suppressed.

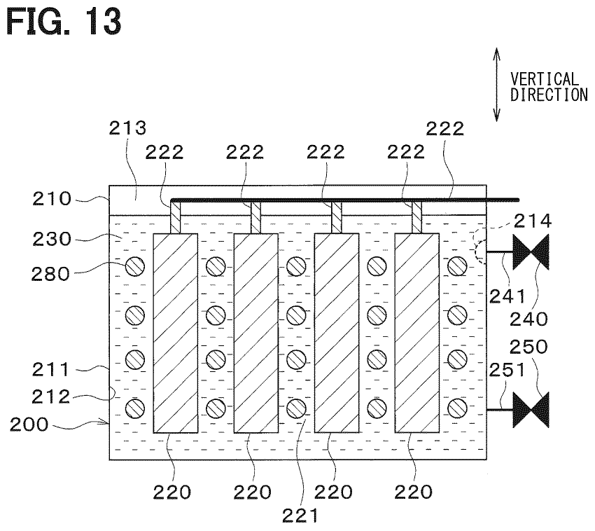

As a modification, as shown in FIG. 13, a filter 214 may be installed inside the cooling tank 210 to block the passage of the latent heat storage material 280 so that the latent heat storage material 280 does not flow out of the cooling tank 210. Of course, the insulating liquid 230 can pass through the filter 214.

The filter 214 is provided at the connection between a pipe 241 and the cooling tank 210. The filter 214 may be provided at the connection between a pipe 251 and the cooling tank 210. In such manner, the latent heat storage material 280 is kept inside the cooling tank 210.

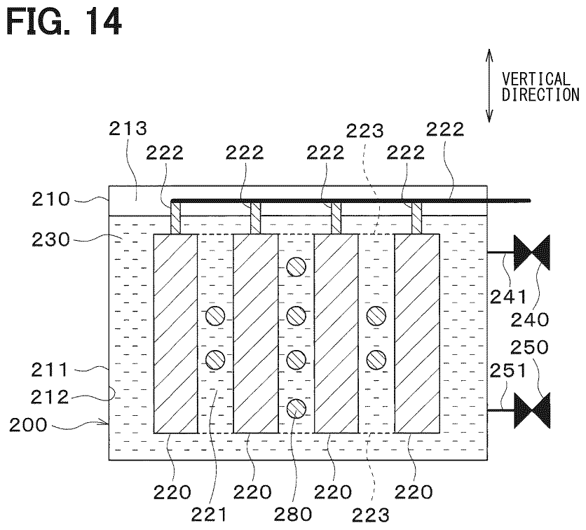

As another modification, as shown in FIG. 14, the latent heat storage material 280 can be placed at a position between adjacent battery cells 220 and a filter 223 between the top and bottom surfaces of the adjacent battery cells 220. In such manner, the latent heat storage material 280 is kept at a position between the adjacent battery cells 220.

In such case, the latent heat storage material 280 is arranged in predetermined quantities at predetermined positions respectively. In other words, a large amount of the latent heat storage material 280 is arranged at high heat generating portions of each of the battery cells 220, and a small amount of the latent heat storage material 280 is arranged at a low heat generating part. In other words, the position and amount of microcapsule latent heat storage material can be controllable.

As described above, by confining the latent heat storage material 280 between adjacent battery cells 220, the temperature distribution due to the distribution of generated heat from each of the battery cells 220 is suppressible. Further, the latent heat storage material 280 does not need to be dispersed in large quantities throughout the entire insulating liquid 230, because the high heat generating portions of each of the battery cells 220 can be cooled intensively. Thus, the amount of the latent heat storage material 280 is reducible.

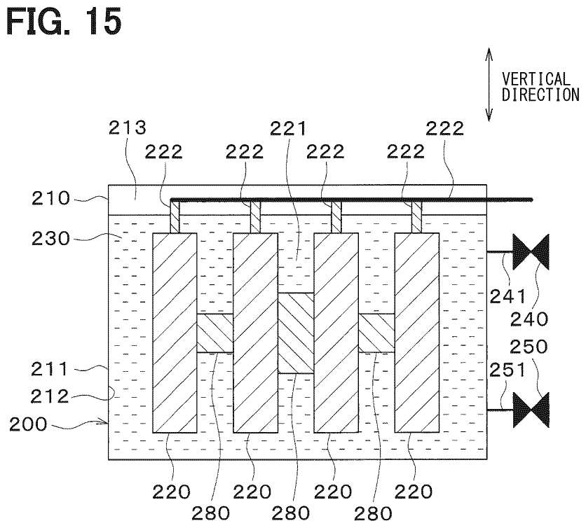

As yet another modification, a fixed heat storage tube may be employed as the latent heat storage material 280, as shown in FIG. 15. When the latent heat storage material 280 is a fixed heat storage tube, more fixed heat storage tubes can be placed at the high heat generating portions of each of the battery cells 220, and fewer fixed heat storage tubes can be placed at the low heat generating portions. That is, the position and size of the fixed heat storage tubes can be controlled.

The fixed heat storage tube is sandwiched between adjacent battery cells 220 so that the insulating liquid 230 between the adjacent battery cells 220 is movable in the vertical direction.

As described above, even when the fixed heat storage tubes are used, temperature distribution due to distribution of generated heat from each of the battery cells 220 is suppressible. It also reduces the amount of the fixed heat storage tubes.

Both of the microcapsule latent heat storage material and the fixed heat storage tubes may be employed as the latent heat storage material 280.

### Fifth Embodiment

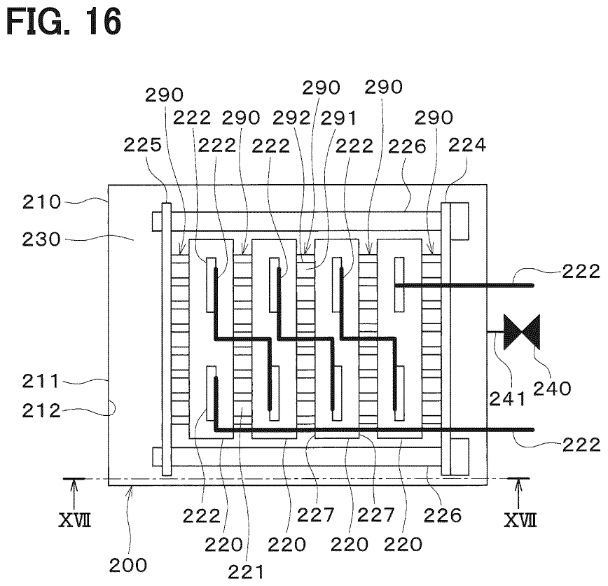

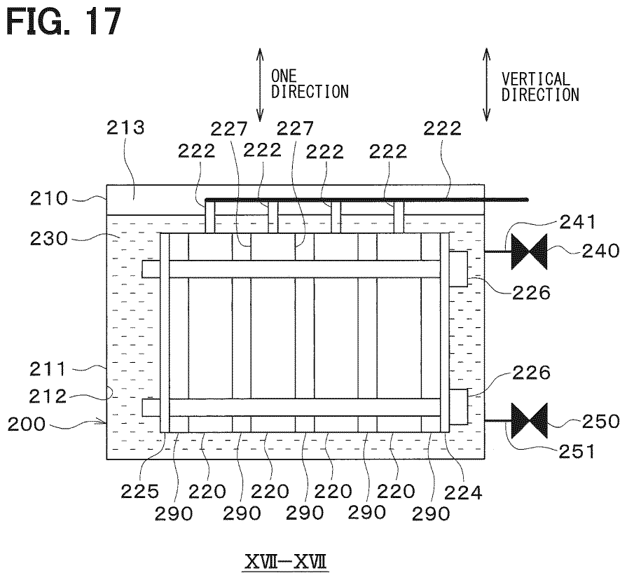

The present embodiment mainly describes the parts that differ from the first through fourth embodiments. FIG. 16 shows a top view of a cooling tank 210 with a lid portion of the cooling tank 210 removed. FIG. 17 shows a XVII - XVII cross sectional view of FIG. 16. As shown in FIGS. 16 and 17, each of battery cells 220 includes an opposing surface 227 that faces the adjacent battery cell 220.

Further, a battery cooling device 200 also includes a spacer member 290. The spacer member 290 is sandwiched between the adjacent battery cells 220 and is in contact with the opposing surfaces 227 of the adjacent battery cells 220. The spacer member 290 is capable of transferring heat of the battery cells 220, which is transmitted through the opposing surfaces 227 of the adjacent battery cells 220, to an insulating liquid 230.

A battery cooling device 200 includes a pair of plates 224, 225 and arresting screws 226 for securing, to the battery cells 220, the spacer members 290 between the battery cells 220. The pair of plates 224 and 225 are arranged at one end and the other end of a stacked body in a stacking direction of each of the battery cells 220 and the spacer member 290, and sandwich the stacked body. The arresting screw 226 tightens the stacked body so that the pair of plates 224 and 225 are brought closer to each other. In such manner, the spacer member 290 and each of the battery cells 220 are bound.

In the present embodiment, the spacer members 290 are also arranged at a position between (i) each of the battery cells 220 arranged at both ends of each of the battery cells 220 and (ii) each of the plates 224 and 225. The spacer member 290 does not have to be positioned between (i) the battery cell 220 arranged at both ends of each of the battery cells 220 and (ii) the respective plates 224 and 225. In other words, each of the battery cells 220 arranged at both ends of each of the battery cells 220 and each of the plates 224 and 225 may be in direct contact with each other. In such case, each of the plates 224 and 225 may be provided with through holes so that the insulating liquid 230 can directly contact the battery cell 220 through the through holes.

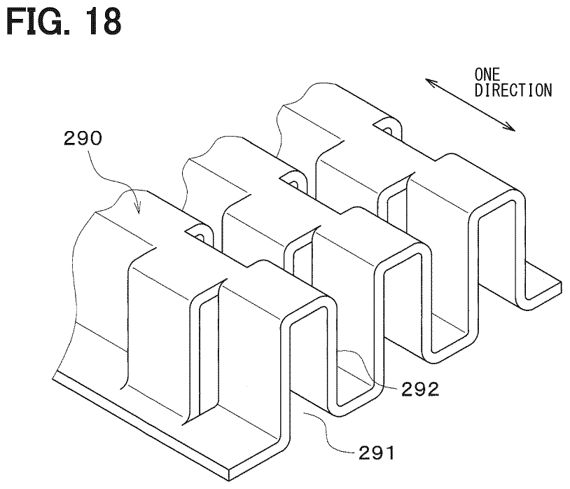

As shown in FIG. 18, offset fins are employed as the spacer members 290 in the present embodiment. Offset fins are fins which have wave shape cross-sections respectively having partially cut-and-raised portions formed therein. Offset fins are formed by a metal with excellent thermal conductivity, such as Al, for example.

The spacer member 290 includes a passage 291 and a support 292. The passage 291 is a portion where the insulating liquid 230 can flow in one of the directions parallel to the opposing surface 227 of the battery cell 220. The support 292 is sandwiched between the adjacent battery cells 220, and supports the adjacent battery cells 220, thereby maintaining the spacing 221 between the adjacent battery cells 220. The support 292 is strong enough to withstand the load of binding when the spacer member 290 and each of the battery cells 220 are bound by the arresting screws 226.

In the present embodiment, one direction of the spacer member 290 is approximately aligned with the vertical direction. Therefore, the insulating liquid 230 put at a position between the adjacent battery cells 220 can move in the vertical direction through the passage 291 of the spacer member 290.

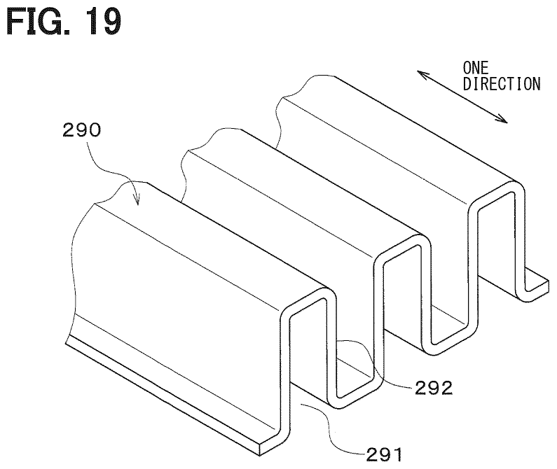

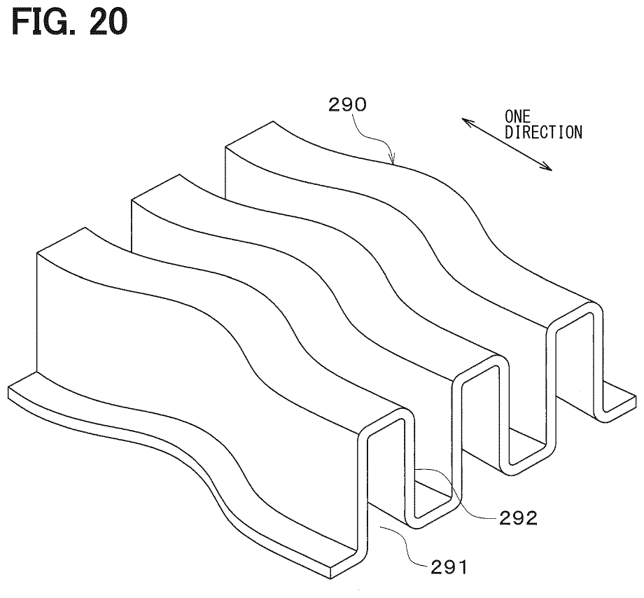

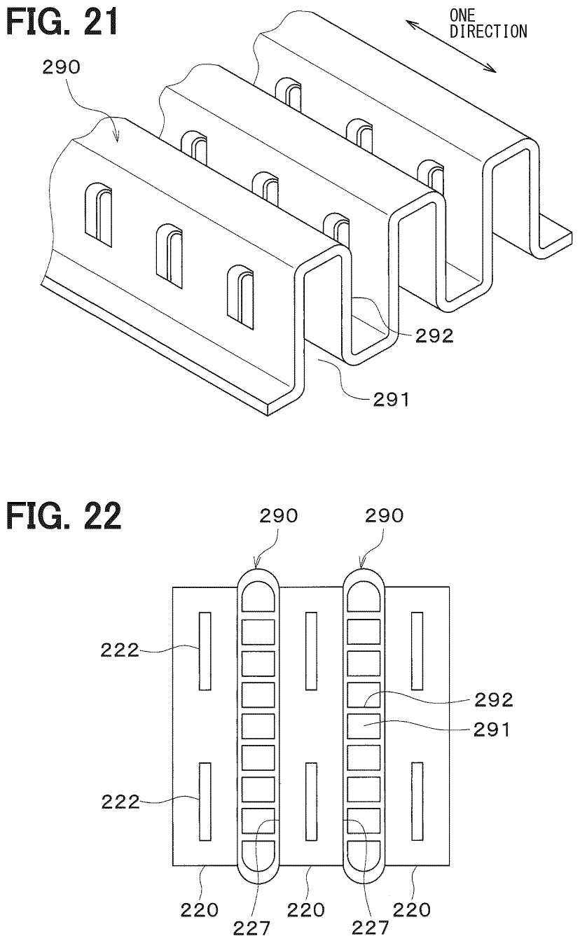

As the spacer member 290, further to the offset fins, corrugated fins shown in FIG. 19, wave fins shown in FIG. 20, and louver fins shown in FIG. 21 may also be employed.

The corrugated fins are metal plate-like members formed into a wavy shape by alternating mountain and valley folds, forming a continuous series of alternating mountain and valley parts. Wave fins are fins that are formed in the shape of a rectangular or trapezoidal wave in cross section as well as meandering along one direction. Louver fins are fins with multiple louvers provided on the wave form that constitutes the corrugated cross section.

According to the above-described configuration, heat of each of the battery cells 220 can be transferred to the insulating liquid 230 without impairing the natural flow of the insulating liquid 230 in one direction. Further, the support 292 of the spacer member 290 maintains the spacing 221 between the adjacent battery cells 220, allowing the spacer member 290 to contact each of the battery cells 220 while restraining both of the spacer member 290 and the battery cells 220.

The microcapsule latent heat storage material shown in the fourth embodiment, for example, is exceedingly small relative to the width of the passage 291 of the spacer member 290, thereby passable through the passage 291. Further, when the fixed heat storage tubes are used as the latent heat storage material 280, both of the spacer members 290 and the fixed heat storage tubes are sandwiched between adjacent battery cells 220.

As a modification, an extrusion tube may be employed as the spacer member 290, as shown in FIG. 22. The extrusion tube is a flattened tube formed by extrusion of metal materials. The inside space of the extrusion tube corresponds to the passage 291. Further, the wall portion comprising a space portion of the extrusion tube corresponds to the support 292.

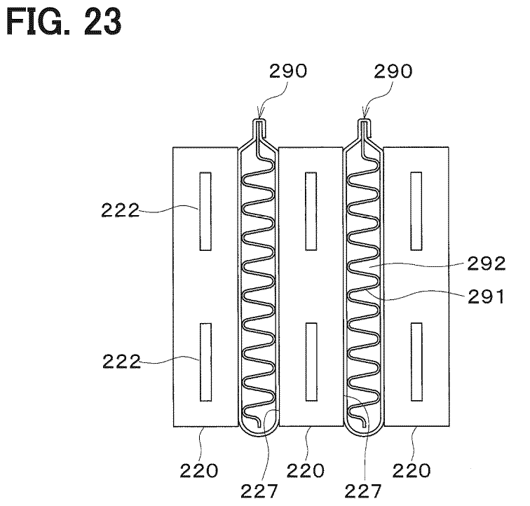

As another modification, an inner fin tube may be employed as the spacer member 290, as shown in FIG. 23. The inner fin tube is a tube made by bending a metal band, which has a flat cross section with one end formed as a bent and the other end calked, and into which an inner fin made of metal band is inserted. With the inner fin in contact with the inner wall of the tube, the other end is calked. The inner space of the inner fin tube corresponds to the passage 291. Further, the inner fin of the inner fin tube corresponds to the support 292.

The microcapsule latent heat storage material shown in the fourth embodiment, for example, is exceedingly small relative to the width of the passage 291 of the extrusion tube and the inner fin tube, thereby passable through the passage 291. When the fixed heat storage tubes are used as the latent heat storage material 280, both of the extrusion tubes and the fixed heat storage tubes are sandwiched between the adjacent battery cells 220. Alternatively, both of the inner fin tubes and the fixed heat storage tubes are sandwiched between the adjacent battery cells 220.

Further, as the spacer member 290, offset fins, corrugated fins, wave fins, louver fins, extrusion tubes, or inner fin tubes may be independently used, or may be used in combination. Of course, more than three of the above may be combined.

Further, the spacer member 290 may also be employed when the battery cell 220 is can-shaped, i.e., has a cylindrical shape. It is possible to bind the can-shaped battery cells 220 and the spacer members 290 by means of the above-described pair of plates 224, 225 and the arresting screws 226 or other binding devices.

In such case, the outer circumference of the can-shaped battery cell 220 corresponds to the opposing surface 227. The direction parallel to the axial direction of the battery cell 220 can be set as one direction. The direction perpendicular to the axial direction of the battery cell 220, i.e., the radial direction, may be set as one direction.

The spacer member 290 is not limited to metal parts, as long as the material can transfer heat from the battery cells 220 to the insulating liquid 230 while maintaining the spacing 221 between the adjacent battery cells 220. The spacer member 290 may, for example, be constructed of a resin material or a combination of metal and resin parts.

### Sixth Embodiment

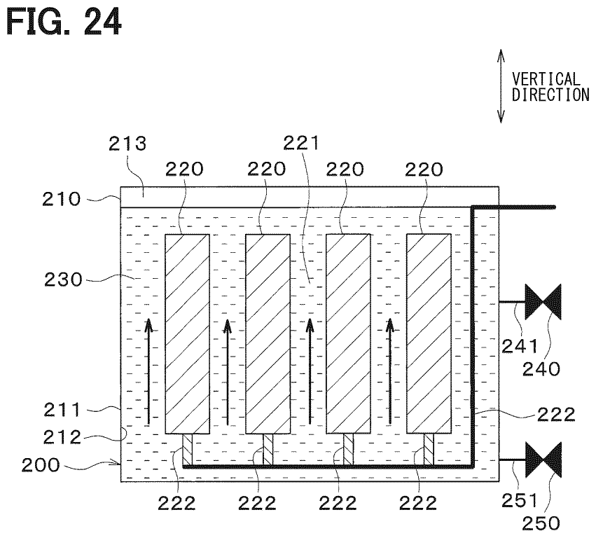

The present embodiment mainly describes the parts that differ from the first through fifth embodiments. As shown in FIG. 24, each of bus bars 222 is arranged at the bottom of a cooling tank 210 with the electrode terminals of each of battery cells 220 pointing toward the ground side in the vertical direction. Further, the bus bar 222 is drawn from the bottom to the top of the cooling tank 210. In other words, the bus bars 222 connecting each of the battery cells 220 are submerged in an insulating liquid 230.

According to the above, the insulating liquid 230, which has become hot by absorbing heat from the bus bar 222 at the bottom of the cooling tank 210, moves to the top of the cooling tank 210. Thus, the convection of the insulating liquid 230 in the vertical direction is promoted, which improves the cooling performance of the insulating liquid 230 for each of the battery cells 220.

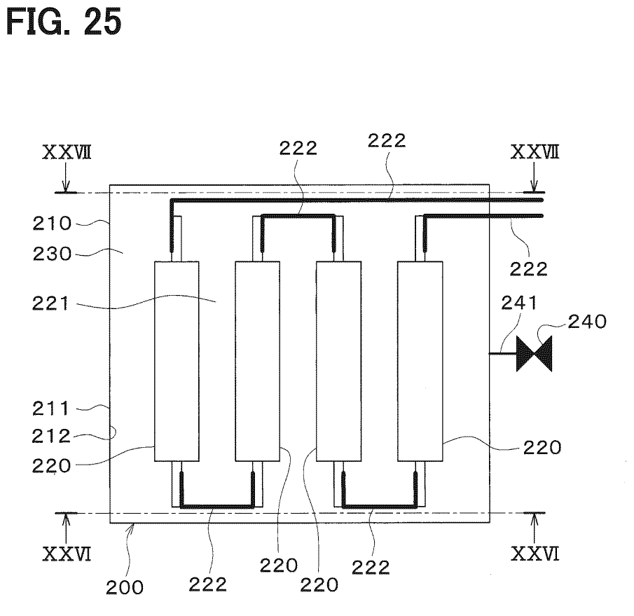

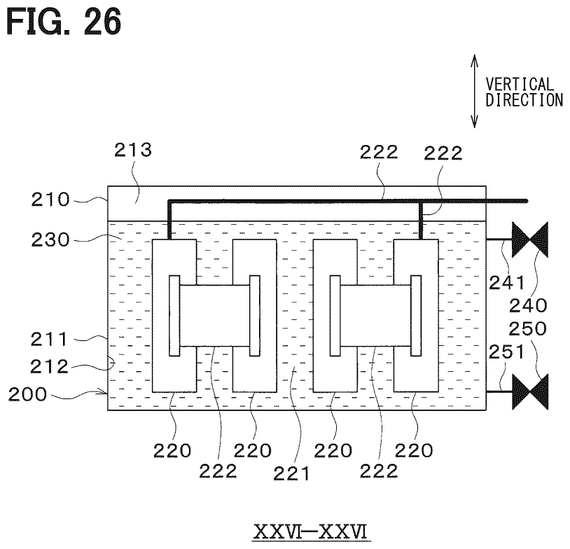

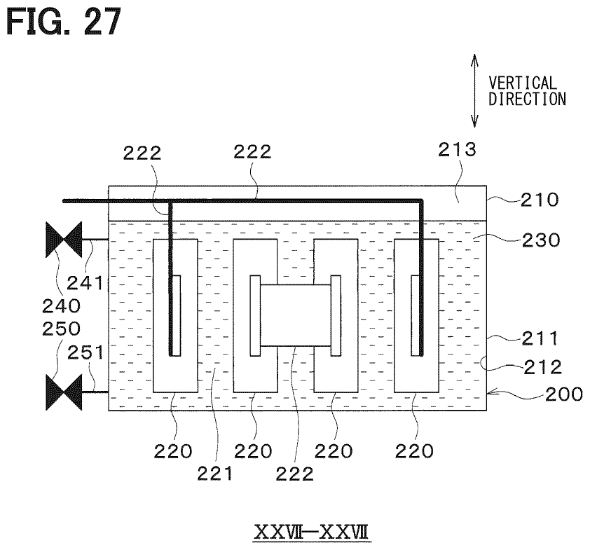

As a modification, as shown in FIGS. 25 through 27, the bus bar 222 connecting the adjacent battery cells 220 may be arranged at a middle depth of the cooling tank 210, by orienting the electrode terminals of each of the battery cells 220 in a direction that is perpendicular to the vertical direction. FIG. 25 shows a top view of the cooling tank 210 in which the lid portion of the cooling tank 210 is removed therefrom.

### Seventh Embodiment

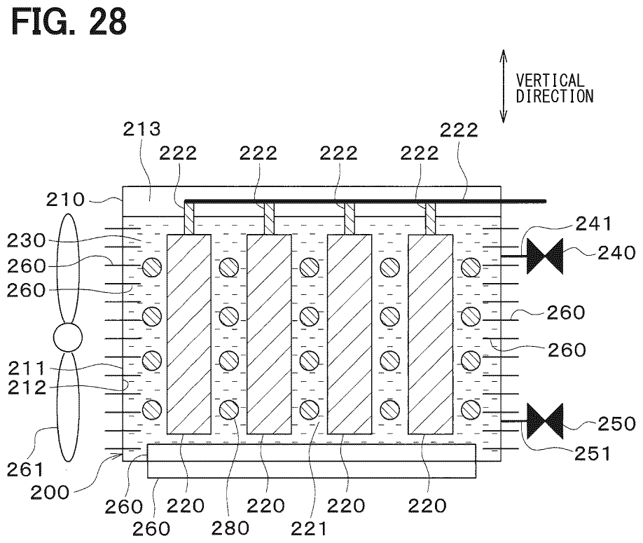

The present embodiment mainly describes the parts that differ from the first through sixth embodiments. As shown in FIG. 28, a battery cooling device 200 is provided with (i) fins 260 on both of an outer wall surface 211 and an inner wall surface 212 of a cooling tank 210 and (ii) a fan 261 outside the cooling tank 210. An insulating liquid 230 is mixed with the microcapsule latent heat storage material as a latent heat storage material 280. In the present embodiment, filters 214 and 223 that restrict the movement of the latent heat storage material 280 are not provided on the cooling tank 210.

According to the above-described configuration, during flight (discharge) time of an eVTOL 100, each of battery cells 220 and bus bar 222 are cooled by the insulating liquid 230 and the latent heat storage material 280 to store heat. Further, the forced air cooling from outside of the cooling tank 210 by the fan 261 promotes heat dissipation from inside of the cooling tank 210 to the outside.

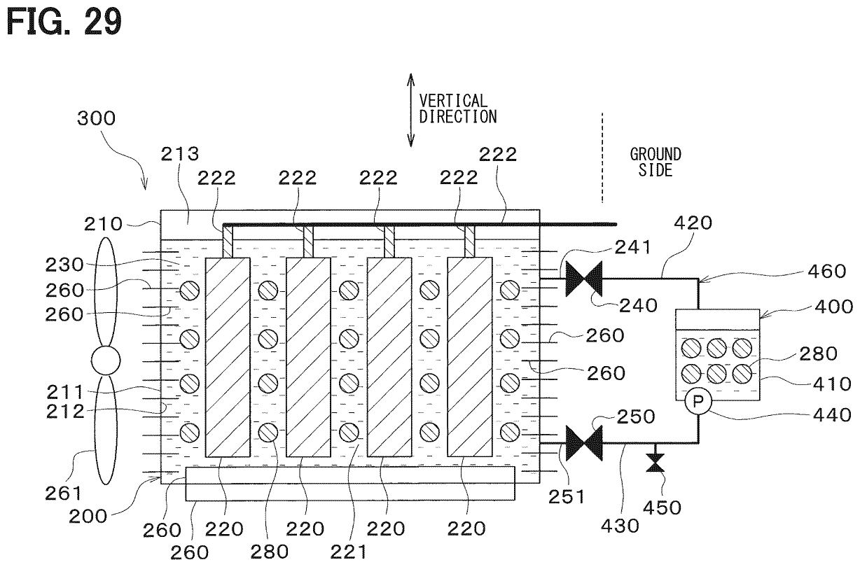

When the eVTOL 100 is on the ground (charging), the cooling tank 210 of the battery cooling device 200 is connected to a low-temperature cooling device 400 on the ground, as shown in FIG. 29. The insulating liquid 230 in a tank 410 of the low-temperature cooling device 400 is pre-cooled and the insulating liquid 230 is mixed with the microcapsule latent heat storage material as the latent heat storage material 280. A controller 500 is omitted to be shown in FIG. 29.

Then, the battery cooling device 200 and the low-temperature cooling device 400 are connected via valve couplings 240 and 250 to form a cooling circulation circuit 460. Thereafter, the pre-cooled, low-temperature insulating liquid 230 circulates through the cooling circulation circuit 460. In such manner, rapid cooling of each of the battery cells 220 inside the cooling tank 210 is performed. When circulating the insulating liquid 230 in the cooling circulation circuit 460, the fan 261 of the battery cooling device 200 may be rotated to perform forced air cooling of the cooling tank 210.

As another cooling method, when the eVTOL 100 is on the ground (charging), the insulating liquid 230 inside the cooling tank 210 may be discharged through a discharge valve 450 of a pipe 430 comprising the cooling circulation circuit 460 after connecting the battery cooling device 200 and the low-temperature cooling device 400 via the valve couplings 240 and 250. Thereafter, the insulating liquid 230, which has been pre-cooled in the low-temperature cooling device 400, is filled from the low-temperature cooling device 400 into the battery cooling device 200. Thus, the insulating liquid 230 does not have to circulate through the cooling circulation circuit 460.

For example, after the insulating liquid 230 in the cooling tank 210 is discharged, the low-temperature insulating liquid 230 at low temperature in the low-temperature cooling device 400 is filled therein. Thereafter, the insulating liquid 230 may be circulated in the cooling circulation circuit 460. Alternatively, the insulating liquid 230 may be discharged and infilled repeatedly. In such manner, rapid cooling of each of the battery cells 220 in the cooling tank 210 is performed. The method of repeatedly discharging and infilling the insulating liquid 230 is particularly effective when the spacing 221 between the adjacent battery cells 220 is narrow, i.e., when (a) the flow resistance of the insulating liquid 230 is high and (b) the flow rate of the insulating liquid 230 between battery cells 220 is low.

Alternatively, the insulating liquid 230 at low temperature may be supplied from the cooling tank 210 via the valve coupling 240 at the top of the cooling tank 210 while the insulating liquid 230 in the cooling tank 210 is discharged from the discharge valve 450. In such case, although the insulating liquid 230 is not circulated, the insulating liquid 230 at low temperature can always be supplied to each of the battery cells 220, thereby effectively suppressing heat generation during charging. The discharge valve 450 can then be closed near the end of the charging to allow the inside of the cooling tank 210 to be filled with the low-temperature insulating liquid 230. Of course, when circulating the insulating liquid 230 in the cooling circulation circuit 460, the fan 261 of the battery cooling device 200 may be rotated to perform forced air cooling of the cooling tank 210.

When filling the cooling tank 210 with the insulating liquid 230 after discharging the insulating liquid 230 from the cooling tank 210, at least one valve coupling needs to be provided on the cooling tank 210. In other words, one valve coupling can discharge and fill the insulating liquid 230. Alternatively, multiple valve couplings may be provided on the cooling tank 210, such as two valve couplings for discharging, two valve couplings for filling, and so on. Even when the insulating liquid 230 is circulated in the cooling circulation circuit 460, multiple valve couplings may be provided on the cooling tank 210.

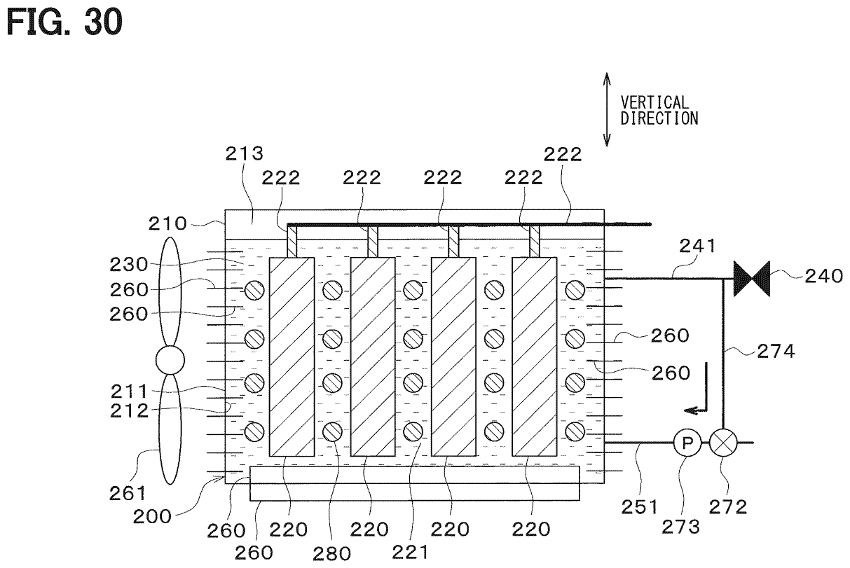

As another cooling method, as shown in FIG. 30, the battery cooling device 200 may include a pipe 274, a three-way valve 272, and a pump 273 instead of the valve coupling 250. Further, oil is employed as the insulating liquid 230.

In such case, during flight (discharge) time of the eVTOL 100, each of the battery cells 220 and the bus bar 222 are cooled by the insulating liquid 230, which is the oil, and the latent heat storage material 280. Further, the cooling tank 210 is forced air-cooled by the fan 261. Further, the oil is circulated inside the cooling tank 210 by the pump 273. In such manner, temperature equalization and accelerated cooling of each of the battery cells 220 are performed.

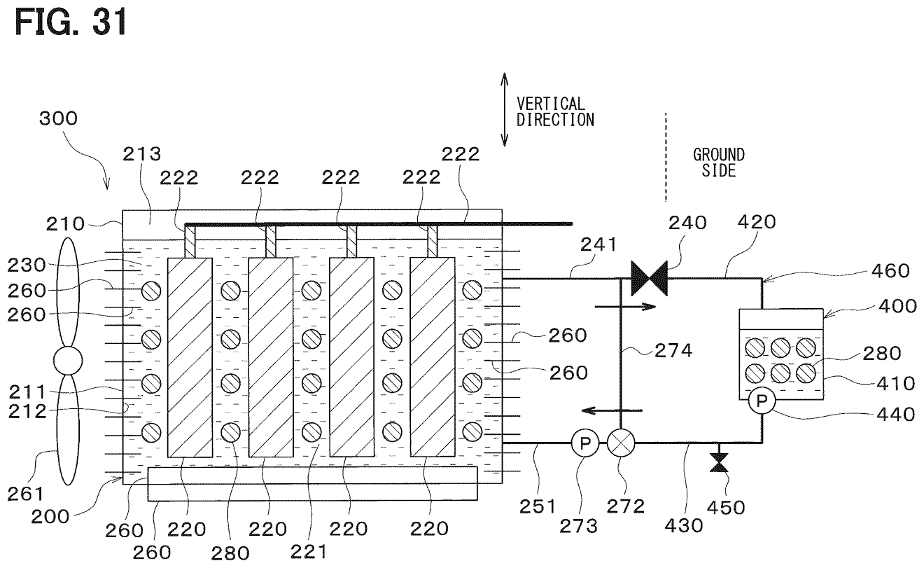

As shown in FIG. 31, when the eVTOL 100 is on the ground (charging), the connection between the pipe 274 and the pipe 251 is blocked by the three-way valve 272 of the cooling tank 210. Further, the valve coupling 240 is connected to the pipe 420 of the low-temperature cooling device 400, and the three-way valve 272 is connected to the pipe 430 of the low-temperature cooling device 400. In such manner, the cooling circulation circuit 460 is formed. The insulating liquid 230 may be flowed by circulating the insulating liquid 230 in the cooling circulation circuit 460 as described above, or by filling the cooling tank 210 with the low-temperature insulating liquid 230 after the insulating liquid 230 is discharged from the cooling tank 210 via the discharge valve 450.

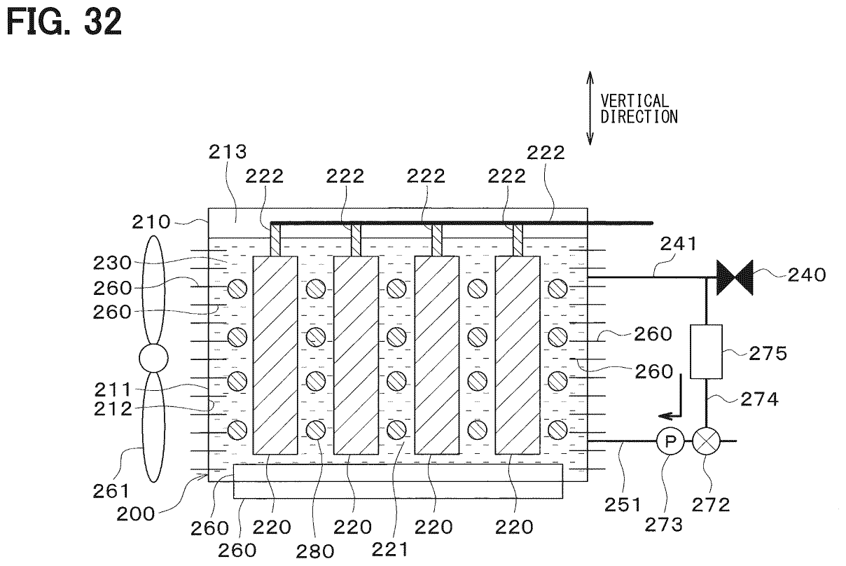

As another cooling method, a heat exchanger 275 may be connected to the pipe 274, as shown in FIG. 32, as a modification of the configuration in FIG. 30. In such manner, the cooling performance of the battery cooling device 200 is further improvable, since external heat dissipation is further increased by the heat exchanger 275 during flight time of the eVTOL 100 (during discharging).

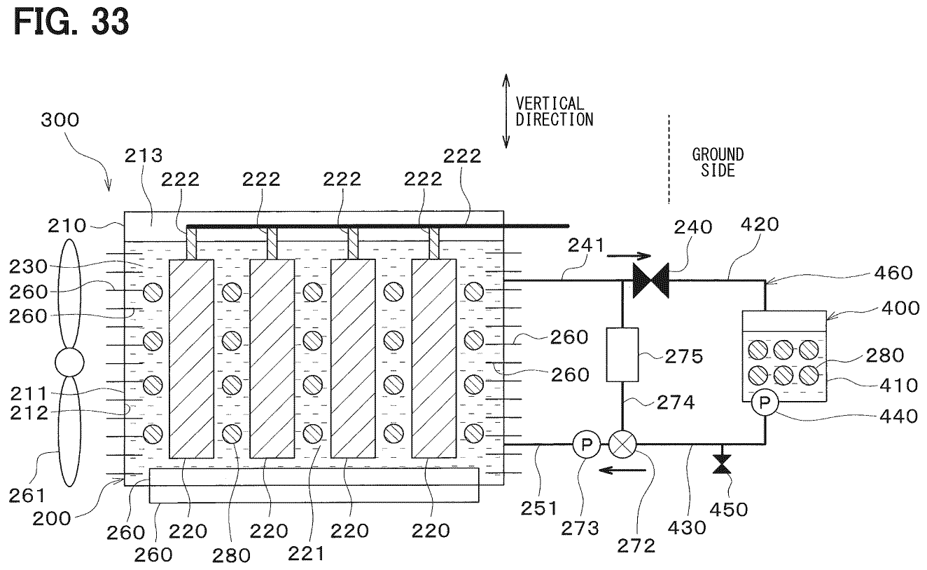

As shown in FIG. 33, when the eVTOL 100 is on the ground (charging), the method of circulating the insulating liquid 230 in the cooling circulation circuit 460 as described above may also be used. Alternatively, after discharging the insulating liquid 230 from the cooling tank 210 via the discharge valve 450, the low-temperature insulating liquid 230 may be filled into the cooling tank 210. When circulating the insulating liquid 230 in the cooling circulation circuit 460, the fan 261 of the battery cooling device 200 may be rotated to perform forced air cooling of the cooling tank 210.

### Eighth Embodiment

The present embodiment mainly describes the parts that differ from the first through seventh embodiments. In the present embodiment, the amount of an insulating liquid 230 in a cooling tank 210 and its initial temperature are optimized according to flight conditions of an eVTOL 100. In other words, an amount and initial temperature of the insulating liquid 230 are adjusted according to the flight conditions of the eVTOL 100. The initial temperature is temperature of the insulating liquid 230 when filling of the insulating liquid 230 into the cooling tank 210 is complete.

Flight conditions include, for example, a flight distance, a flight time, a flight altitude, a flight path, a flight speed, a number of flights, a number of passengers on board, a payload weight, climatic conditions, weather on the flight path, aircraft specifications and the like. In other words, flight conditions are related to the magnitude of the load on the battery pack during flight.

The amount and the initial temperature of the insulating liquid 230 are comprehensively determined from flight conditions known in advance, such as the flight path, and flight conditions that are obtainable before takeoff, such as the weather at the time of flight. The amount and the initial temperature of the insulating liquid 230 are determined before the next flight of the eVTOL 100 by a controller 500 of a battery cooling system 300, for example. The amount and the initial temperature of the insulating liquid 230 are determined, for example, before or after landing of the eVTOL 100.

The amount and the initial temperature of the insulating liquid 230 are calculated from an equation that relates values indicating the flight conditions, the amount and the initial temperature of the insulating liquid 230. Alternatively, the amount and the initial temperature of the insulating liquid 230 according to the flight conditions may be derived from a map showing a relationship between (a) flight conditions and (b) the amount and the initial temperature of the insulating liquid 230.

For example, the controller 500 calculates the required output and usage of each of the battery cells 220 from the flight conditions, and calculates a heat generation amount of each of the battery cells 220 from the required output and usage. The controller 500 calculates the amount and the initial temperature of the insulating liquid 230 to store the heat generation amount of the battery at temperature equal to or below allowable temperature of the battery cells 220. For example, the heat generation amount of the battery may be calculated as follows: heat generation amount of the battery=(battery heat capacity+amount of insulating liquid×specific heat)×(allowable temperature−initial temperature).

The amount and the initial temperature of the insulating liquid 230 may be calculated by a device other than the controller 500. In such case, the controller 500 acquires data on the amount and the initial temperature of the insulating liquid 230 calculated by a device other than the controller 500, and adjusts the amount and the initial temperature of the insulating liquid 230 in the cooling tank 210 based on the acquired data.

Based on the flight conditions, the controller 500 obtains in advance the amount and the initial temperature of the insulating liquid 230 before the next flight of the eVTOL 100. Then, during the grounded (charging) time of the eVTOL 100, the controller 500 optimizes the amount and the initial temperature of the insulating liquid 230 in the cooling tank 210 according to the flight conditions of the eVTOL 100 after rapidly cooling each of the battery cells 220 inside the cooling tank 210. During the rapid cooling of the battery cells 220, the inside of the cooling tank 210 may be filled with the low-temperature insulating liquid 230.

Here, a battery cooling device 200 includes a liquid level gauge. The liquid level gauge is installed in the cooling tank 210, and detects the height of the liquid level of the insulating liquid 230. The liquid level gauge may employ either a method that is in contact with the insulating liquid 230 or a method that is non-contact with the insulating liquid 230. The liquid level gauge outputs measurement results to the controller 500.

The controller 500 adjusts the amount of the insulating liquid 230 in the cooling tank 210 by controlling the pump 440 based on measurement results of the liquid level gauge. In such manner, the controller 500 controls the amount of the insulating liquid 230 in the cooling tank 210 to vary, according to the flight conditions of the eVTOL 100. For example, the controller 500 decreases the amount of the insulating liquid 230 below a standard amount for a first flight condition (low load flight), and increases the amount of the insulating liquid 230 above the standard amount for a second flight condition (high load flight).

The amount of the insulating liquid 230 in the cooling tank 210 may be measured by a flow sensor. The flow sensor is installed in the pipe for pumping the insulating liquid 230 to the cooling tank 210. For example, the flow sensor is installed in a pipe 251 of the battery cooling device 200 and in a pipe 430 of the battery cooling system 300. The controller 500 controls the flow rate of the insulating liquid 230 pumped into the cooling tank 210 based on a signal from the flow sensor.

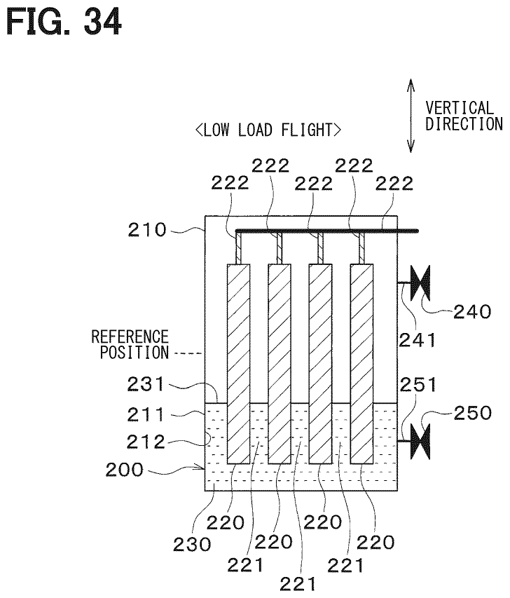

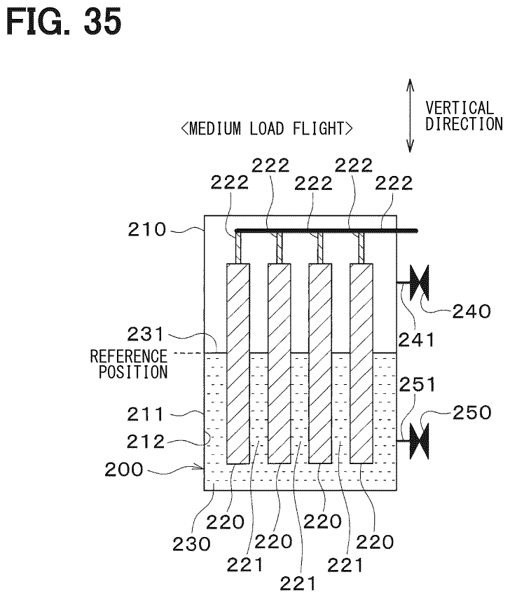

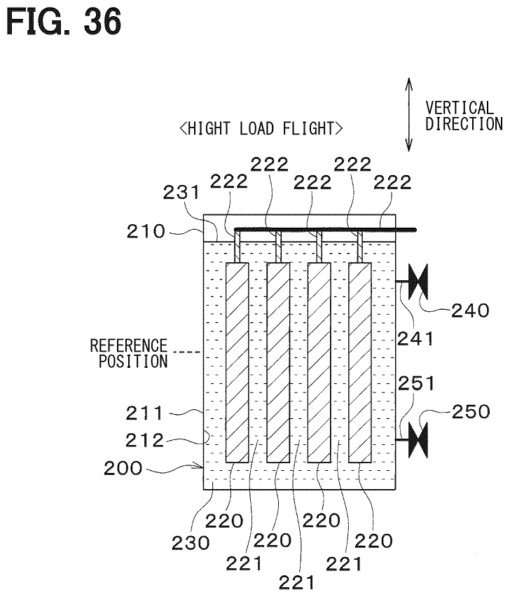

FIGS. 34 through 36 show an optimized amount of the insulating liquid 230, respectively. FIG. 34 shows the amount of the insulating liquid 230 during a low load flight. FIG. 35 shows the amount of the insulating liquid 230 during a medium-load flight. FIG. 36 shows the amount of the insulating liquid 230 during a high load flight.

As shown in FIG. 34, when each of the battery cells 220 is in a low load according to the flight conditions, a liquid level 231 of the insulating liquid 230 is lower than a reference position, for example, in the cooling tank 210. That is, the amount of the insulating liquid 230 is reducible. Thus, when each of the battery cells 220 is under low load, the battery cooling device 200 is made lighter.

As shown in FIG. 35, when each of the battery cells 220 bears medium load according to the flight conditions, the liquid level 231 of the insulating liquid 230 is, for example, near the reference position in the cooling tank 210. In such manner, the cooling performance of the insulating liquid 230 is ensured while reducing the amount of the insulating liquid 230 to reduce weight. The liquid level 231 of the insulating liquid 230 may be positioned above the reference position of the cooling tank 210, or below the reference position of the cooling tank 210.

As shown in FIG. 36, when each of the battery cells 220 bears high load according to the flight conditions, the insulating liquid 230 immerses the entire battery case comprising the battery cell 220. In such manner, the cooling performance of the insulating liquid 230 for the battery cell 220 is ensured. The position of the liquid level 231 of the insulating liquid 230 may be adjusted so that part of the battery case is exposed from the insulating liquid 230. As described above, the amount of the insulating liquid 230 accommodated in the cooling tank 210 varies according to the flight conditions of the eVTOL 100.

Because each of the battery cells 220 is immersed in the insulating liquid 230 in the battery cooling device 200, it is easy to adjust the amount of the insulating liquid 230. Further, when the amount of the insulating liquid 230 in the cooling tank 210 is changed, the liquid level 231 of the insulating liquid 230 with respect to the multiple battery cells 220 accommodated in the cooling tank 210 changes evenly. In other words, each of the battery cells 220 is evenly immersed in the insulating liquid 230. Therefore, each of the battery cells 220 is evenly cooled.

In conventional technology, a cooler is disposed in each battery cell. Therefore, even when the amount of cooling liquid is changed, it is difficult to vary the amount of cooling liquid for each of the battery cells 220 evenly. Therefore, the cooling performance of each battery cell will vary.

However, when the amount of the insulating liquid 230 is changed on the ground according to the flight conditions, as in the present embodiment, the liquid level 231 of the insulating liquid 230 for the multiple battery cells 220 accommodated in the cooling tank 210 changes evenly, thereby enabling each of the battery cells 220 to be cooled evenly.

Even when optimizing the amount of the insulating liquid 230, each of the above embodiments may be combined as much as possible.

The present disclosure is not limited to the embodiments described above, but may be changed in various ways within the scope that does not depart from the intent of the present disclosure, as follows.

For example, the opposing surface 227 of each of the battery cells 220 needs not be parallel to the vertical direction, but may be tilted with respect to the vertical direction. Even in such case, the insulating liquid 230 between the adjacent battery cells 220 is still movable to the ground side by gravity.

Alternatively, each of the battery cells 220 may be housed in the cooling tank 210, so that the opposing surface 227 of each of the battery cells 220 is perpendicular to the vertical direction. In other words, the opposing surfaces 227 of each of the battery cells 220 may be arranged along the horizontal direction. Of course, the opposing surface 227 of each of the battery cells 220 needs not be parallel to the horizontal direction, but may be tilted with respect to the horizontal direction.

As the insulating liquid 230, a phase-change material that solidifies at about the lower limit temperature of use of the battery cell 220 may be employed. The phase-change material is liquid in the normal operating temperature range of the battery cells 220 (about 10 degrees in Celsius to 60 degrees in Celsius), and absorbs heat from each of the battery cells 220. In a special case where the temperature is close to the lower limit of the normal operating temperature range of the battery cell 220, the liquid phase change material solidifies, i.e., releases latent heat. In such manner, the temperature of the battery cell 220 is maintained at the lower limit temperature of the operating temperature range without dropping below the operating temperature range. Therefore, the temperature drop of the battery cell 220 equal to or below the lower limit temperature of the operating temperature range is suppressible. It can also ensure that the output of the battery cells 220 is prevented from dropping during landing.

Although the present disclosure has been described in accordance with examples, it is understood that the present disclosure is not limited to the examples or structures. The present disclosure includes various modifications or deformations within an equivalent range. Further, various combinations and embodiments, as well as other combinations and embodiments, including one or more elements, or less than one element, also fall within the scope and idea of the present disclosure.

The technical features of the battery cooling device and the battery cooling system disclosed herein are as follows.

### (Item 1)

A battery cooling device to be applied to an electrically-powered flying object (100), includes:
a cooling tank (210); a plurality of battery cells (220) housed in the cooling tank; an insulating liquid (230) accommodated in the cooling tank to flow therein, and immersing the plurality of battery cells to absorb heat from the plurality of battery cells; and a valve coupling (240, 250, 272) provided at the cooling tank, and configured to detachably attach a low-temperature cooling device (400), to allow the insulating liquid in the cooling tank to flow into and flow out of the low-temperature cooling device (400).

(Item 2)

In the battery cooling device of item 1, the plurality of battery cells are electrically connected to each other by a bus bar (222), and at least a part of the bus bar is in contact directly with the insulating liquid.

### (Item 3)

In the battery cooling device of item 1 or 2,
the cooling tank includes an outer wall surface (211) and an inner wall surface (212), and
the cooling tank further includes fins (260) that are disposed on either of the outer wall surface, the inner wall surface, or both of the outer and inner wall surfaces, to dissipate heat from an inside of the cooling tank to an outside of the cooling tank.

### (Item 4)

In the battery cooling device of any one of items 1 to 3, the cooling tank includes a flow device (270) configured to make a flow of the insulating liquid.

### (Item 5)

The battery cooling device of any one of items 1 to 4, further includes a latent heat storage material (280) added to the insulating liquid, to store or dissipate heat using an inflow or outflow of latent heat due to a phase change.

### (Item 6)

In the battery cooling device of any one of items 1 to 5, the insulating liquid is a non-flammable, fluorinated liquid.

### (Item 7)

In the battery cooling device of any one of items 1 to 5, the insulating liquid is oil.

### (Item 8)

In the battery cooling device of any one of items 1 to 7, the plurality of battery cells are arranged adjacent to each other with a spacing (221) between two adjacent battery cells, and each battery cell has an opposing surface (227) facing the adjacent battery cell. The battery cooling device further includes a spacer member (290) sandwiched between the adjacent two of the battery cells, and contacting the opposing surfaces of the adjacent battery cells, to transfer heat from the battery cells to the insulating liquid via the opposing surfaces. In addition, the spacer member includes a passage (291) in which the insulating liquid flows in one of directions parallel to the opposing surfaces of the battery cell, and a support (292) contacting the opposing surfaces of the battery cells and maintaining the spacing between the adjacent battery cells.

(item 9)

In the battery cooling device of any one of items 1 to 8, when a center position of the cooling tank in a vertical direction as a reference position, the valve coupling is arranged at a lower position than the reference position of the cooling tank in a vertical direction.

### (Item 10)

In the battery cooling device of any one of items 1 to 8, the valve coupling is provided at a position of the cooling tank where the insulating liquid is present.

### (Item 11)

In the battery cooling device of any one of items 1 to 10,the insulating liquid is accommodated in the cooling tank in different amounts according to flight conditions of the electrically-powered flying object.

### (Item 12)

A battery cooling system to be applied to an electrically-powered flying object (100), includes:
a battery cooling device (200) that includes
a cooling tank (210),
a plurality of battery cells (220) housed in the cooling tank,
an insulating liquid (230) accommodated in the cooling tank to flow therein, and immersing the plurality of battery cells to absorb heat from the plurality of battery cells, and
a valve coupling (240, 250, 272) provided at the cooling tank, and configured to detachably attach a low-temperature cooling device (400), to allow the insulating liquid in the cooling tank to flow into and flow out of the low-temperature cooling device (400);
the low-temperature cooling device cooling and storing the insulating liquid; and
a controller (500) configured to control the low-temperature cooling device. In addition, the battery cooling device and the low-temperature cooling device are connected via the valve coupling to configure a cooling circulation circuit (460) in which the insulating liquid circulates between the battery cooling device and the low-temperature cooling device, and the controller is configured to circulate the insulating liquid pre-cooled by the low-temperature cooling device in the cooling circulation circuit.

### (Item 13)

A battery cooling system to be applied to an electrically-powered flying object (100), includes:
A Battery Cooling Device (200) That Includes
a cooling tank (210),
a plurality of battery cells (220) housed in the cooling tank,
an insulating liquid (230) accommodated in the cooling tank to flow therein, and immersing the plurality of battery cells to absorb heat from the plurality of battery cells, and
a valve coupling (240, 250, 272) provided at the cooling tank, and configured to detachably attach a low-temperature cooling device (400), to allow the insulating liquid in the cooling tank to flow into and flow out of the low-temperature cooling device (400);
the low-temperature cooling device cooling and storing the insulating liquid; and
a controller (500) configured to control the low-temperature cooling device. In addition, the battery cooling device and the low-temperature cooling device are connected via the valve coupling to configure a cooling circulation circuit (460) in which the insulating liquid circulates between the battery cooling device and the low-temperature cooling device, and the controller is configured to introduce the insulating liquid, pre-cooled by the low-temperature cooling device, from the low-temperature cooling device to the battery cooling device, after discharging the insulating liquid inside the cooling tank via the cooling circulation circuit.

### (Item 14)

In the battery cooling system of item 12 or 13, the controller controls an amount of the insulating liquid accommodated in the cooling tank to vary in accordance with flight conditions of the electrically-powered flying object.

What is claimed is:

1. A battery cooling device to be applied to an electrically-powered flying object, the battery cooling device comprising:
a cooling tank;
a plurality of battery cells housed in the cooling tank;
an insulating liquid accommodated in the cooling tank to flow therein, and immersing the plurality of battery cells to absorb heat from the plurality of battery cells; and
a valve coupling provided at the cooling tank, and configured to detachably attach a low-temperature cooling device, to allow the insulating liquid in the cooling tank to flow into and flow out of the low-temperature cooling device.

2. The battery cooling device of claim 1, wherein
the plurality of battery cells are electrically connected to each other by a bus bar, and
at least a part of the bus bar is in contact directly with the insulating liquid.

3. The battery cooling device of claim 1, wherein
the cooling tank includes an outer wall surface and an inner wall surface, and
the cooling tank further includes fins that are disposed on either of the outer wall surface, the inner wall surface, or both of the outer and inner wall surfaces, to dissipate heat from an inside of the cooling tank to an outside of the cooling tank.

4. The battery cooling device of claim 1, wherein
the cooling tank includes a flow device configured to make a flow of the insulating liquid.

5. The battery cooling device of claim 1, further comprising:
a latent heat storage material added to the insulating liquid, to store or dissipate heat using an inflow or outflow of latent heat due to a phase change.

6. The battery cooling device of claim 1, wherein
the insulating liquid is a non-flammable, fluorinated liquid.

7. The battery cooling device of claim 1, wherein
the insulating liquid is oil.

8. The battery cooling device of claim 1, wherein
the plurality of battery cells are arranged adjacent to each other with a spacing between two adjacent battery cells, and each battery cell has an opposing surface facing the adjacent battery cell,
the battery cooling device further comprising:
a spacer member sandwiched between the adjacent two of the battery cells, and contacting the opposing surfaces of the adjacent battery cells, to transfer heat from the battery cells to the insulating liquid via the opposing surfaces, wherein
the spacer member includes:
a passage in which the insulating liquid flows in one of directions parallel to the opposing surfaces of the battery cell; and
a support contacting the opposing surfaces of the battery cells and maintaining the spacing between the adjacent battery cells.

9. The battery cooling device of claim 1, wherein
when a center position of the cooling tank in a vertical direction as a reference position, the valve coupling is arranged at a lower position than the reference position of the cooling tank in a vertical direction.

10. The battery cooling device of claim 1, wherein
the valve coupling is provided at a position of the cooling tank, where the insulating liquid is present.

11. The battery cooling device of claim 1, wherein
the insulating liquid is accommodated in the cooling tank in different amounts according to flight conditions of the electrically-powered flying object.

12. The battery cooling device of claim 8, wherein
the spacer member is made of one of offset fins, corrugated fins, wave fins, louver fins, a flattened tube or inner fin tube.

13. A battery cooling system to be applied to an electrically-powered flying object, the battery cooling system comprising:
a battery cooling device that includes
a cooling tank,
a plurality of battery cells housed in the cooling tank,
an insulating liquid accommodated in the cooling tank to flow therein, and immersing the plurality of battery cells to absorb heat from the plurality of battery cells, and
a valve coupling provided at the cooling tank, and configured to detachably attach a low-temperature cooling device, to allow the insulating liquid in the cooling tank to flow into and flow out of the low-temperature cooling device;
the low-temperature cooling device cooling and storing the insulating liquid; and
a controller configured to control the low-temperature cooling device, wherein
the battery cooling device and the low-temperature cooling device are connected via the valve coupling to configure a cooling circulation circuit in which the insulating liquid circulates between the battery cooling device and the low-temperature cooling device, and
the controller is configured to circulate the insulating liquid pre-cooled by the low-temperature cooling device in the cooling circulation circuit.

14. A battery cooling system to be applied to an electrically-powered flying object, the battery cooling system comprising:
a battery cooling device that includes
a cooling tank,
a plurality of battery cells housed in the cooling tank,
an insulating liquid accommodated in the cooling tank to flow therein, and immersing the plurality of battery cells to absorb heat from the plurality of battery cells, and
a valve coupling provided at the cooling tank, and configured to detachably attach a low-temperature cooling device, to allow the insulating liquid in the cooling tank to flow into and flow out of the low-temperature cooling device;
the low-temperature cooling device cooling and storing the insulating liquid; and
a controller configured to control the low-temperature cooling device, wherein
the battery cooling device and the low-temperature cooling device are connected via the valve coupling to configure a cooling circulation circuit in which the insulating liquid circulates between the battery cooling device and the low-temperature cooling device, and
the controller is configured to introduce the insulating liquid, pre-cooled by the low-temperature cooling device, from the low-temperature cooling device to the battery cooling device, after discharging the insulating liquid inside the cooling tank via the cooling circulation circuit.

15. The battery cooling system of claim 13, wherein
the controller controls an amount of the insulating liquid accommodated in the cooling tank to vary in accordance with flight conditions of the electrically-powered flying object.

16. The battery cooling system of claim 14, wherein
the controller controls an amount of the insulating liquid accommodated in the cooling tank to vary in accordance with flight conditions of the electrically-powered flying object.
